(19) United States
(12) Patent Application Publication
(10) Pub. No.: US 2011/0088084 A1
(43) Pub. Date: Apr. 14, 2011

(54) INFORMATION STORAGE APPARATUS, RECORDING MEDIUM, AND METHOD

(75) Inventors: Kouichi YASAKI, Kawasaki (JP); Kazuaki Nimura, Kawasaki (JP); Yousuke Nakamura, Kawasaki (JP); Isamu Yamada, Kawasaki (JP); Zhaogong Guo, Kawasaki (JP)

(73) Assignee: FUJITSU LIMITED, Kawasaki-shi (JP)

(21) Appl. No.: 12/903,354

(22) Filed: Oct. 13, 2010

(30) Foreign Application Priority Data
Oct. 14, 2009 (JP) 2009-236965

(51) Int. Cl. H04L 9/32; G06F 21/00

(52) U.S. Cl. 726/5; 726/2

(57) ABSTRACT

A storage apparatus includes: an access acceptance unit to receive an access request associated with an access from a host apparatus; an authentication processing unit to judge whether the access is authenticated or unauthenticated; a storage unit including a first area that stores first data and a second area that stores second data serving as a substitute for the first data; a data switching unit to allow, when the access acceptance unit judges the access as authenticated, the access to the first area and switches the access to the second area in a case where the authentication processing unit judges the access as unauthenticated, the access to the second data in the second area being provided to disguise that the access was unauthenticated.

### CROSS-REFERENCE TO RELATED APPLICATIONS

This application is based upon and claims the benefit of priority of the prior Japanese Patent Application No. 2009-236965, filed on Oct. 14, 2009, the entire contents of which are incorporated herein by reference.

### FIELD

Embodiments described herein relate to a technology for protecting information stored in an information storage apparatus from an unauthorized access.

### BACKGROUND

In order to protect classified data stored in an information storage apparatus, an access to the classified data is restricted. For example, before the access to the classified data, a user of the information storage apparatus is asked to enter a password, and an authentication is performed on the basis of the entered password and a previously registered password. As a result, the access to the classified data is permitted only to the authenticated user. In contrast, the access to the classified data is denied for an unauthorized user who is not authenticated. In the authentication, in general, the entry of a password is allowed up to a specified number of times. If the authentication fails (e.g., the password does not match previously registered password, re-entry of the password is requested by the information storage apparatus until the number of entry tries reaches an upper limit value (e.g., specified number of times).

Also, Japanese Unexamined Patent Application Publication No. 11-259425 discusses an information storage apparatus for comparing a degree of difference between an entered password and a previously registered password. When the information storage apparatus according to Japanese Unexamined Patent Application Publication No. 11-259425 determines, for example, that the access is not authorized, a power supply is turned OFF, and the access by the unauthorized user is denied.

### SUMMARY

According to an aspect of the invention, an access acceptance unit to receive an access request associated with an access from a host apparatus; an authentication processing unit to judge whether the access is authenticated or unauthenticated; a storage unit including a first area that stores first data and a second area that stores second data serving as a substitute for the first data; a data switching unit to allow, when the access acceptance unit judges the access as authenticated, the access to the first area and switches the access to the second area in a case where the authentication processing unit judges the access as unauthenticated, the access to the second data in the second area being provided to disguise that the access was unauthenticated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram for a storage area of an information storage apparatus.

FIG. 2 is a block diagram showing the information storage apparatus and a host apparatus.

FIG. 3 is a block diagram showing a function of the information storage apparatus.

FIG. 4A and FIG. 4B show authentication results stored by an authentication result storage unit.

FIG. 5 shows a data switching table.

FIG. 6A and FIG. 6B show a count condition table.

FIG. 7A, FIG. 7B, and FIG. 7C are explanatory diagrams for describing a dummy data generation method.

FIG. 8 shows a count result storage unit.

FIG. 9 is a flow chart showing a flow of an overall processing executed by the information storage apparatus.

FIG. 10 is a flow chart showing a flow of an authentication processing.

FIG. 11 is a flow chart showing a flow of a switching processing to dummy data.

FIG. 12 is a flow chart showing a flow of an invalidation processing on restricted-access data.

FIG. 13 shows a screen for setting the count condition table which is displayed on a display of the host apparatus.

FIG. 14 shows information included in a registration command for setting a count area and an invalidation method.

FIG. 15 is a flow chart showing a flow of a setting processing for the data switching table and the count condition table.

FIG. 16 shows the data switching table and the count condition table.

FIG. 17 is an explanatory diagram of a storage area of an information storage apparatus.

FIG. 18 is a block diagram showing a function of the information storage apparatus.

FIG. 19 shows an access status storage unit.

FIG. 20 is a block diagram showing a function of the information storage apparatus.

FIG. 21 is a flow chart showing a flow of an overall processing executed by the information storage apparatus.

FIG. 22 is a schematic diagram for describing the authentication processing in a case where a plurality of authentication passwords are set.

FIG. 23 is a schematic diagram for describing the authentication processing in a case where a plurality of authentication passwords are set.

### DESCRIPTION OF EMBODIMENTS

When an apparatus requests re-entry of a password and then deactivates or turns OFF a power supply to the apparatus, an unauthorized user can figure out that the authentication failed (e.g., the entered password did not match a previously registered password). For that reason, in a case where the unauthorized user figures out that the authentication failed, the unauthorized user may attempt to exploit the classified data by disassembling the information storage apparatus, for example.

In view of the above, a technology is provided for protecting the data by inhibiting and/or preventing the unauthorized user from figure out that the authentication failed. Stated differently, the authentication failure is disguised.

An information storage apparatus according to an embodiment performs data input and output with a host apparatus and may includes the following.
An access acceptance unit to receive an access request associated with an access from a host apparatus.
An authentication processing unit to judge whether the access is authenticated or unauthenticated.
A storage unit including a first area that stores first data and a second area that stores second data serving as a substitute for the first data.
A data switching unit to allow, when the access acceptance unit judges the access as authenticated, the access to the first area and switches the access to the second area in a case where the authentication processing unit judges the access as unauthenticated, the access to the second data in the second area being provided to disguise that the access was unauthenticated.

The information storage apparatus stores the first data in the first area of the storage unit and stores the second data in the second area. Herein, for example, the first data is restricted-access data to which the access is limited, and the second data is dummy data serving as the substitute for the restricted-access data. The information storage apparatus permits the access from the host apparatus to the storage unit in a case where the authentication succeeds. Therefore, the host apparatus can access to the first area where the access is restricted. However, in a case where the authentication fails, the information storage apparatus switches the access to the second area where the second data is stored. Therefore, when authentication fails, the host apparatus which is not authenticated is inhibited and/or prevented from accessing the first area.

However, even in a case where the authentication fails, the host apparatus is not denied access to the storage unit (e.g., the host apparatus can access the second area. For that reason, a user of the host apparatus does not receive an indication or have the impression that the authentication failed. For that reason, the information storage apparatus induces the access from the host apparatus which is not authenticated up to a threshold for denying the access, and the invalidation of the first data can be executed by the invalidation unit. According to the above-described embodiment, the first data is protected from unauthorized accesses such as the leak, the falsification, and the exploitation through damaging or destruction of the information storage apparatus.

Also, the first area or the second area has the target area which is the measurement target for the first access status and the non-target area which is not the measurement target. In the case of access from a host apparatus which is not authenticated, the information storage apparatus obtains the first access status only with regard to the target area of the first area or the second area and invalidates the first data when this first access status reaches a threshold. Even a rightful user attempting access may fail the authentication because of an erroneously entered password, for example. As described above, limiting an area to monitor an access status generates an area the access status of which is not counted, thereby extending time until the number of accesses reaches the threshold for the length of time generated by not-counting the area. Accordingly, compared with the case where access statuses of all areas are monitored, time until invalidation processing is executed is extended even with substantially the same threshold. Moreover, time until invalidation processing is executed is extended compared with the case where an area of the storage unit is immediately invalidated when the authentication fails. As described above, extending time from authentication failure to invalidation provides a margin of time, in other words, an extra time to the user. Thus, usability for the rightful user is improved.

The information storage apparatus further includes a target area decision unit.

The target area decision unit measures, in a case where the authentication in the authentication processing unit succeeds, a second access status including a number of accesses or an access duration for every access to the first area or the second area from the host apparatus and decides the target area on the basis of the second access status.

The target area decision unit obtains the second access status by the rightful user and decides the target area on the basis of the obtained second access status. For example, the target area decision unit decides an access destination where the number of accesses is small as the target area. Therefore, it is possible to save the rightful user from having to set the target area. Also, as the target area is set on the basis of the second access status, as compared with the setting by the user, it is possible to accurately set the area where the number of accesses by the rightful user is small as the target area.

It should be noted that as the access status constantly changes, the target area decision unit may also change the target area in accordance with the change of the second access status as needed. According to this, the setting of the target area in accordance with the access status can be performed.

The information storage apparatus further includes a first processing unit and a second processing unit.

The first processing unit accepts, in a case where the authentication in the authentication processing unit succeeds, the access from the host apparatus and allows the access to the first area in accordance with the access.

The second processing unit accepts, in a case where the authentication in the authentication processing unit fails, the access from the host apparatus and allows the access to the second area in accordance with the access.

The data switching unit activates the first processing unit in a case where the authentication in the authentication processing unit succeeds and activates the second processing unit in a case where the authentication in the authentication processing unit fails.

The access measurement unit measures the first access status when it is determined that the access accepted by the second processing unit from the host apparatus is the access to the target area of the first area or the second area.

In accordance with the success or failure of the authentication, the information storage apparatus respectively activates one of the first processing unit and the second processing unit, and after that, until the activation of the information storage apparatus stops, the activated processing unit performs transmission and reception of the commands, the data, and the like with the host apparatus. Therefore, it is not necessary to refer to the authentication result in the authentication processing unit each time the information storage apparatus receives the command and the like from the host apparatus, and a time used for the access processing accompanied by the access from the host apparatus is suppressed as a whole.

The information storage apparatus further stores passwords.

Between the host apparatus and the information storage apparatus, an apparatus password unique to the host apparatus is set. A user password is set by a user of the host apparatus.

The authentication processing unit determines whether or not an access to the storage unit is authenticated on the basis of any one of the apparatus password and the user password.

For example, it is assumed that the information storage apparatus authenticates only the access with the host apparatus on the basis of the apparatus password. In this case, if the host apparatus cannot be used because of a malfunction or the like, the access cannot be made to the information storage apparatus. However, as the user password is set, it is also possible to access the storage unit on the basis of the user password.

### OTHER EMBODIMENTS

(1) Outline

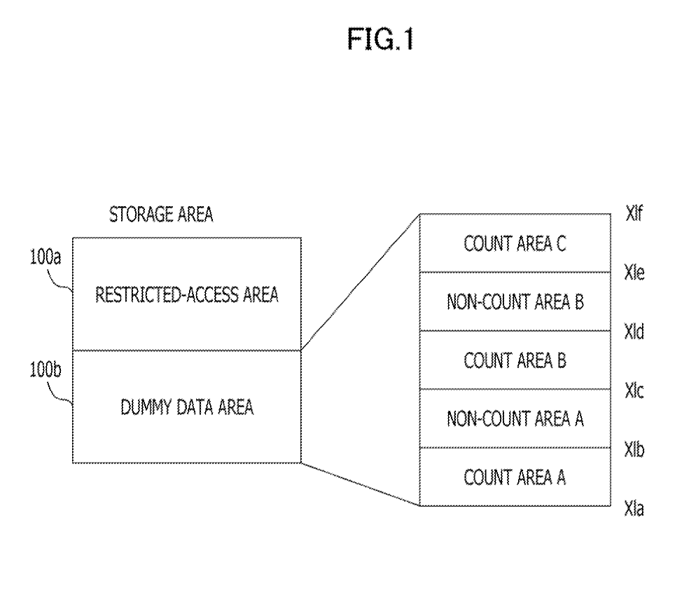

FIG. 1 is an explanatory diagram of a storage area of an information storage apparatus according to another embodiment example. A storage area of an information storage apparatus 100 includes a restricted-access area 100a and a dummy data area 100b. The restricted-access area 100a stores restricted-access data where the access is restricted, and the access to the restricted-access data may be made, for example, only in a case where an authentication succeeds. The dummy data area 100b stores dummy data serving as a substitute for the restricted-access data. In addition, although not shown, the storage area stores an OS (Operating System), various programs such as firmware, other various pieces of data, and the like.

In a case where the authentication succeeds, the information storage apparatus 100 permits the access to the storage area, and the access is made to the restricted-access area 100a. On the other hand, in a case where the authentication fails, the information storage apparatus 100 prohibits the access to the restricted-access area 100a, and the access is switched to the access to the dummy data area 100b. Accordingly, the unauthorized user failing the authentication is prevented from accessing the restricted-access data. However, as the unauthorized user obtains the dummy data rather than the restricted-access data, the unauthorized user does not receive the impression that the authentication failed. Accordingly, the unauthorized user who is unable to determine whether the obtained data is dummy data or not, operates the information processing apparatus. As a result, the unauthorized user continues to access the data until the number of accesses reaches the threshold to deny the access, and invalidation processing to the restricted-access data is executed. Accordingly, the restricted-access data is protected from unauthorized accesses such as the leak, the falsification, and the exploitation through damage or destruction of the information storage apparatus.

Also, as shown in FIG. 1, the dummy data area 100b includes the count areas A, B, and C and non-count areas A and B. When the authentication fails, the access is switched to the access to the dummy data area 100b, but the information storage apparatus 100 obtains an access status such as the number of accesses and/or the access duration in a case where the access destination is included in the count areas A, B, and C. The information storage apparatus 100 does not obtain the access status in a case where the access destination is within the non-count areas A and B. The information storage apparatus 100 performs a processing of invalidating the restricted-access data in the restricted-access area 100a on the basis of only the access status to the count areas A, B, and C. For example, in a case where the authentication fails, it is assumed that the number of accesses to the count area A and the count area B of the dummy data area 100b reaches a threshold of five times in the accumulated total. The information storage apparatus 100 invalidates the restricted-access data through deletion, overwrite, or the like to protect the restricted-access data from the leak, the falsification, or the like through the unauthorized access.

Herein, even a rightful user attempting an access may fail because of an erroneously entered password or the like. With the above-mentioned configuration, even when the authentication by the rightful user fails, as compared with the case where all the areas of the dummy data area 100b are count areas, a margin to the invalidation of the restricted-access data is expanded. For example, when no confidential information is included in an area such as a kernel that accesses an information storage apparatus for activation, the area is set as a non-count area. Setting the non-count area reduces, if not prevents, counting the number of accesses to the threshold value, because an access is performed typically to the information storage apparatus when a boot is performed by using the dummy data. As a result, invalidating the restricted-access data during a boot, or immediately after the boot may be reduced, if not prevented. Therefore, a sufficient time is provided to the rightful user who inputs an erroneous password to recognize that the access is performed to the dummy data, and thereby reducing, if not preventing the limited-access data from being invalidated. Thus, usability of the rightful user is improved. In other words, compared with the case in which access statuses of all areas are counted, setting an area for counting the access status is more effective when an authentication is being failed. For example, the unauthorized user accesses various data. On the other hand, the rightful user accesses a certain type of data, and the access by the rightful user indicates some trend. Thus, setting a count area to count accesses by utilizing differences in access trends between the unauthorized user and the rightful user who inputs erroneous password may efficiently count accesses by the unauthorized user. Meanwhile, a margin of time is extended until the rightful user who inputs erroneous password notices data in the activated area is dummy data. According to this, it is possible to design the information storage apparatus 100 also taking into account the case where the authentication by the rightful user fails.

(2) Overall Configuration

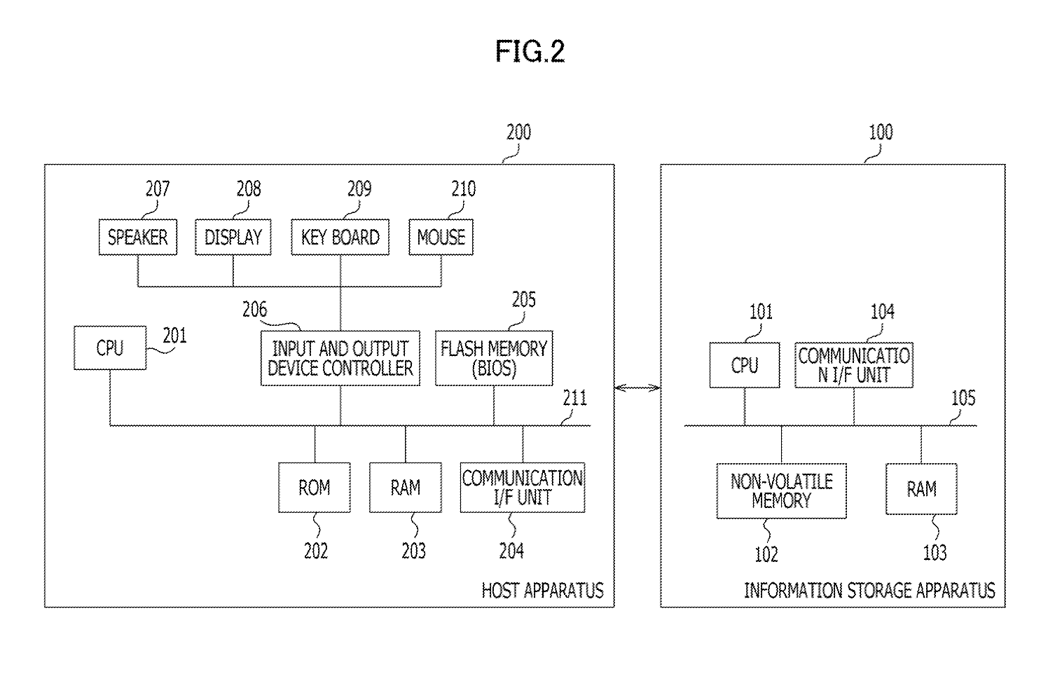

FIG. 2 is a block diagram showing examples of overall configurations and hardware configurations of the information storage apparatus and a host apparatus. The information storage apparatus 100 is connected, for example, via an interface such as SCSI (Small Computer System Interface) and ATA (Advanced Technology Attachment) to a host apparatus 200. Also, the information storage apparatus 100 may also be connected to the host apparatus 200 via a network such as the internet. The user reads and writes the data stored in the information storage apparatus 100 by using the host apparatus 200. Therefore, the information storage apparatus 100 performs a processing in accordance with a command such as a write command for requesting data write from the host apparatus 200 and a read command for requesting data read.

(3) Hardware Configuration

By using FIG. 2 again, the hardware configurations of the information storage apparatus 100 and the host apparatus 200 will be described.

The information storage apparatus 100 has, for example, a CPU (Central Processing Unit) 101, a non-volatile memory 102, a RAM (Random Access Memory) 103, and a communication I/F (Inter Face) 104. These components are mutually connected via a bus 105.

For the information storage apparatus 100, for example, a memory card, a USB (Universal Serial Bus) memory, a hard disk, an SSD (Solid State Drive), and the like are exemplified.

The non-volatile memory 102 stores a program called firmware for causing the CPU 101 to execute basic control of the information storage apparatus 100. Various controls for inhibiting and/or preventing the unauthorized access to the restricted-access data according to embodiments described herein may be realized through the execution of the firmware. The non-volatile memory 102 is, for example, a storage apparatus which is capable of permanently storing and is also rewritable, and as an example, a flash memory such as an EEPROM (Electrically Erasable Programmable Read Only Memory) is exemplified.

The CPU 101 temporarily stores the firmware stored in the non-volatile memory 102 in the RAM 103 and executes basic of the information storage apparatus 100 and various controls according to embodiments described herein.

The RAM 103 temporarily stores the firmware in the non-volatile memory 102. Also, the RAM 103 stores various pieces of data including the restricted-access data and the dummy data.

The communication I/F 104 perform communication such as transmission and reception of the command or the data with the host apparatus 200, for example.

The information storage apparatus 100 may be further provided with a ROM, and the restricted-access data, the dummy data, and the like may be stored in the ROM.

On the other hand, in the host apparatus 200, a CPU 201, a ROM 202, a RAM 203, the communication I/F 204, a flash memory 205, and an input and output device controller 206 are connected via a bus 211. Also, a speaker 207, a display 208, a key board 209, a mouse 210, and the like are connected to the input and output device controller 206.

The input and output device controller 206 accepts an input from the user via the speaker 207, the display 208, the key board 209, the mouse 210, and the like and also outputs video and audio. For example, the key board 209, the mouse 210, and the like accept an input of a password for enabling an access to the information storage apparatus 100 from the user. Also, for example, the key board 209, the mouse 210, and the like read the data from the information storage apparatus 100, write the data to the information storage apparatus 100, and accept a request such as rewrite of the firmware in the information storage apparatus 100 or the like from the user. The speaker 207, the display 208, and the like output the data read from the information storage apparatus 100.

The flash memory 205 stores a BIOS (Basic Input Output System) which is a basic program for a password setting, a control on peripheral devices connected to the host apparatus 200, and the like.

The ROM 202 stores various control programs related to various controls on the host apparatus 200.

The RAM 203 temporarily stores the BIOS, the various control programs, and the like.

The CPU 201 develops the BIOS stored in the flash memory 205 and the various control programs stored in the ROM 202 into the RAM 203 to perform the control on the host apparatus 200. A generation of a command to be transmitted to the information storage apparatus 100 on the basis of the various requests accepted from the user is also one of the processing carried out by the CPU 201. For example, the commands include an authentication command, a read command, a write command, and a registration command. The authentication command is generated on the basis of an authentication request from the user and includes, for example, the password input by the user and the like. The read command and the write command include an address of an access destination and the like. The registration command is generated on the basis of a rewrite request for the firmware in the information storage apparatus 100 and includes a rewrite location and a rewrite content of the firmware and the like.

The communication I/F 204 perform the communication such as, e.g., the transmission and the reception of a command and/or data with the information storage apparatus 100.

(4) Functional Configuration

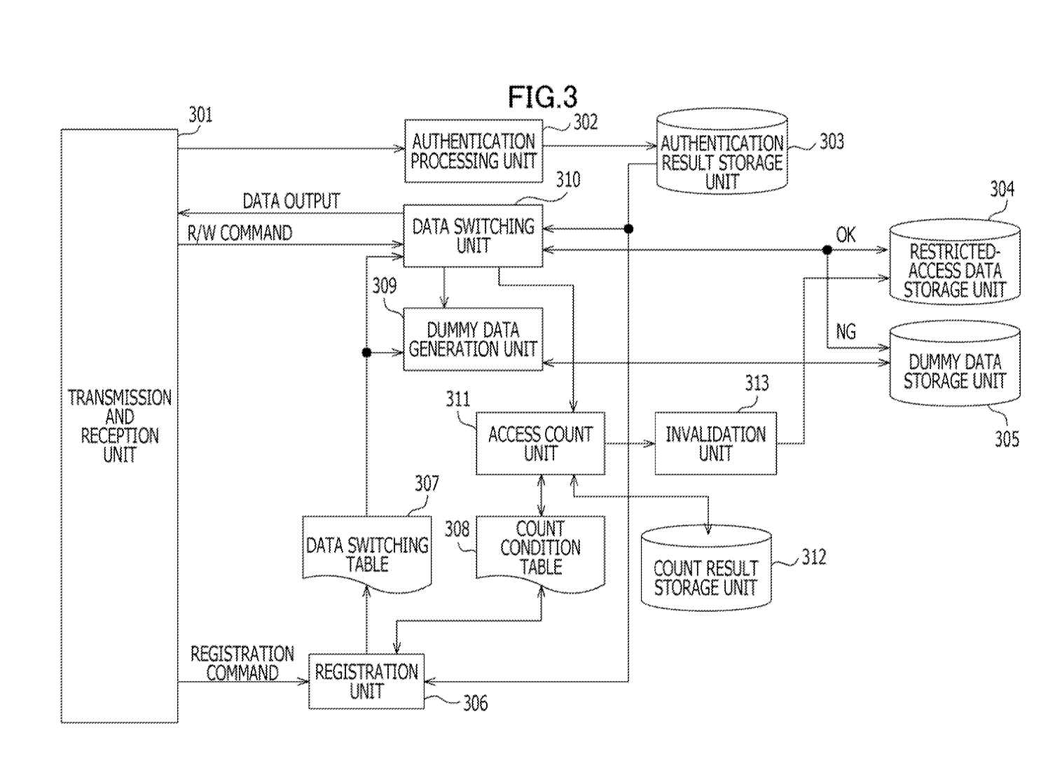

FIG. 3 is a block diagram showing the information storage apparatus. Functions shown in FIG. 3 may be realized by the CPU 101 of the information storage apparatus 100 executing firmware stored in the non-volatile memory 102. Hereinafter, a description will be given of the respective configurations of FIG. 3.

(4-1) Transmission and Reception Unit

A transmission and reception unit 301 receives various commands input from the host apparatus 200 and transmits the commands to the respective function units. For example, the transmission and reception unit 301 receives the authentication command from the host apparatus 200 and outputs the authentication command to an authentication processing unit 302. Also, the transmission and reception unit 301 outputs the read command and the write command to a data switching unit 310. Also, the transmission and reception unit 301 outputs the registration command to a registration unit 306.

(4-2) Authentication Processing Unit, Authentication Result Storage Unit

The authentication processing unit 302 performs an authentication processing for determining whether or not an access from the host apparatus 200 is authenticated. First, the authentication processing unit 302 receives the authentication command including a password input by the user from the transmission and reception unit 301. The authentication processing unit 302 receives the authentication command and performs an authentication processing before the host apparatus 200 accesses the storage area of the information storage apparatus 100 for the first time, for example, at the activation of the information storage apparatus 100. The authentication processing unit 302 registers an authentication password used for the authentication in advance and compares the password input by the user with the authentication password stored in advance to determine whether the access from the host apparatus 200 is authenticated. The authentication processing unit 302 outputs an authentication result to an authentication result storage unit 303.

In addition, when the authentication processing unit 302 receives the access to the storage area even though the authentication command is not received, the authentication processing unit 302 does not authenticate the access.

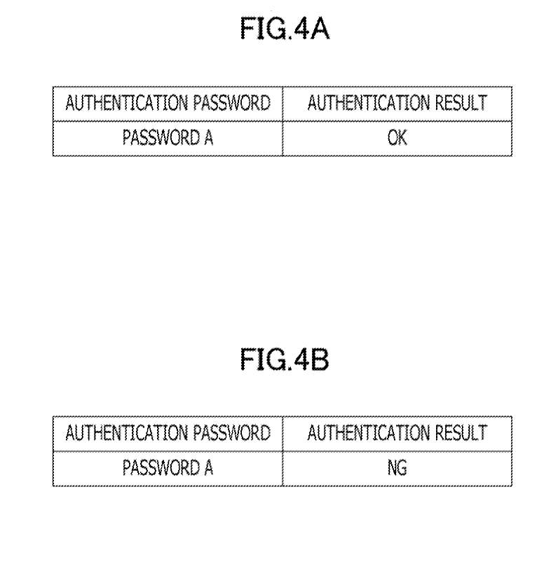

FIG. 4A and FIG. 4B show authentication result examples stored by the authentication result storage unit. The authentication result storage unit 303 stores an authentication result received from the authentication processing unit 302. For example, a password A is registered as the authentication password, and in a case where the authentication succeeds, as shown in FIG. 4A, “OK” is stored in the authentication result. In contrast, in a case where the authentication fails, for example, as shown in FIG. 4B, “NG” is stored in the authentication result. The authentication result storage unit 303 holds the authentication result, for example, from a time when the authentication processing unit 302 performs the authentication at the time of the activation until a time when a power supply of the information storage apparatus 100 is turned OFF. After the authentication result is stored in the authentication result storage unit 303, in a case where the access is made a plurality of times from the host apparatus 200 to the information storage apparatus 100, the authentication result is read out and utilized in accordance with the respective authentication results. For that reason, the information storage apparatus 100 may not perform the authentication processing each time the host apparatus 200 accesses the information storage apparatus 100. Accordingly, the time used for the authentication processing is reduced, and the information storage apparatus 100 suppresses the time used for the access processing accompanied by the access from the host apparatus 200 as a whole. It should be noted that when the information storage apparatus 100 is activated again, the authentication processing is performed again, and the authentication result storage unit 303 stores a new authentication result.

(4-3) Limit-access Data Storage Unit, Dummy Data Storage Unit

A restricted-access data storage unit 304 stores the restricted-access data to which the access is limited. Only in a case where the authentication succeeds, the access may be made to the restricted-access data. The restricted-access data, for example, may be classified information which is disclosed only to particular users and the like.

A dummy data storage unit 305 stores the dummy data serving as the substitute for the restricted-access data. The dummy data storage unit 305 stores dummy data generated by a dummy data generation unit 309 which will be described below, dummy data taken in from an external apparatus, and the like.

It should be noted that hereinafter, the data storage units 304 and 305 include the restricted-access data storage unit 304 and the dummy data storage unit 305.

(4-4) Registration Unit

When the registration command is received from the transmission and reception unit 301, first, the registration unit 306 refers to the authentication result storage unit 303 to obtain information as to whether or not the access from the host apparatus 200 is authenticated. In a case where the authentication succeeds, the registration unit 306 accepts a rewrite request of the firmware included in the registration command, and on the basis of the registration command, a registration processing for various conditions in a data switching table 307, a count condition table 308, and the like is performed. On the other hand, in a case where the authentication fails, the registration unit 306 does not perform the registration processing even when the registration command is received.

The registration command includes, for example, an address of a count area specified by the rightful user. As the specification of the count area is accepted from the rightful user, the degree of freedom for the rightful user with regard to the setting of the count area can be increased.

(4-5) Data Switching Table

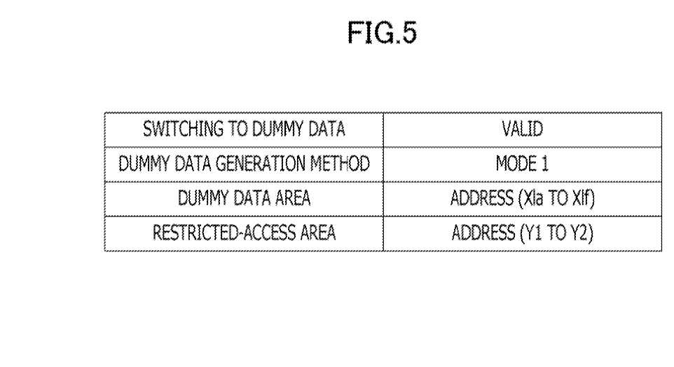

FIG. 5 shows an example of the data switching table. The data switching table 307 stores items related to the data switching set on the basis of the registration command by the registration unit 306. For example, the data switching table 307 stores information as to whether or not the switching to the dummy data is valid or invalid, that is, information as to whether or not the access is allowed to the dummy data storage unit 305 in a case where the authentication fails. In a case where the switching to the dummy data is “valid”, the access to the restricted-access data storage unit 304 is prohibited, and instead, the access is switched to the dummy data storage unit 305. In addition, the data switching table 307 stores the mode for specifying the generation method for the dummy data, the address of the dummy data area, the address of the restricted-access area, and the like. In the example of FIG. 5, for example, when the switching to the dummy data is “valid”, that is, in a case where the authentication fails, the setting is to output the dummy data instead of the restricted-access data. Also, in the case of the example shown in FIG. 5, the dummy data generation unit 309 generates the dummy data through a generation method of a mode 1 which will be described below and stores the dummy data at addresses “Xla to Xlf” as shown in FIG. 1. Also, the restricted-access data is stored at addresses “Y1 to Y2”.

Herein, the dummy data generation unit 309 which will be described below generates the dummy data, for example, through a duplication by taking a snapshot of the restricted-access data storage unit 304. In this case, the address of the address spaces Xla to Xlf of the dummy data area 100b is preferably associated with the address of the address spaces Y1 to Y2 of the restricted-access area 100a.

(4-6) Count Condition Table

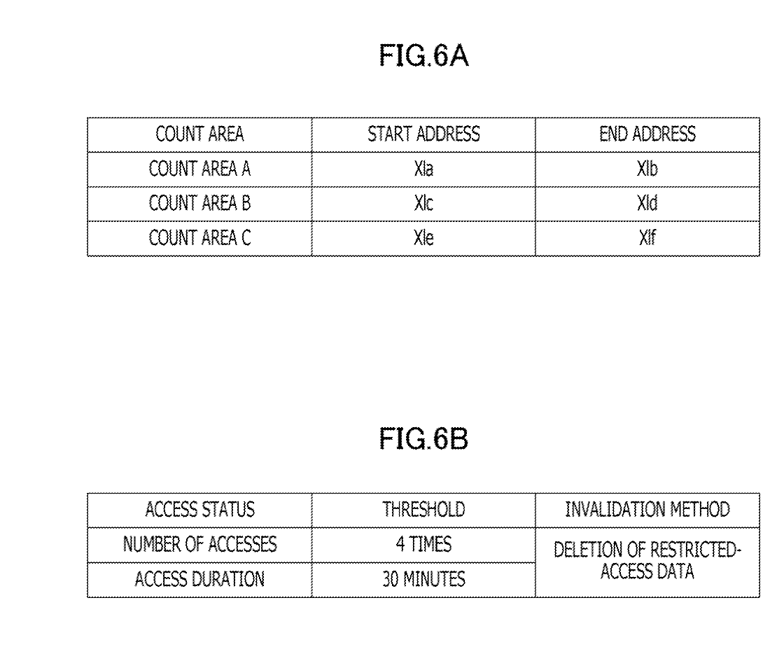

FIG. 6A and FIG. 6B show examples of the count condition table. The count condition table 308 stores items related to obtaining the access status set on the basis of the registration command by the registration unit 306. For example, the count condition table 308 stores a location of the count area for obtaining the access status. In the example of FIG. 6A, the count areas A, B, and C are set in the dummy data area 100b shown in FIG. 1 on the basis of a start address and an end address. For example, the start address for the count area A is “Xla”, and the end address is “Xlb”.

The access status is an index representing which status the access is in. Although not particularly limited, the access status is represented, for example, by the number of accesses, the access duration, the accumulation of the access periods, and the like. Obtaining the access status may be performed, for example, through any method for measuring the access status by counting the number of accesses, or the like.

Herein, in the access performed relating to the data storage units 304 and 305 in a case where the authentication succeeds, an area where the number of accesses and/or the access duration is smaller than others is preferably set as the count area. In other words, by setting an area to which the rightful user seldom accesses as a count area, the number of times that the accesses by the rightful user is counted is reduced compared with when the count area is arbitrarily set. Therefore, even if the authentication of the rightful user fails, and as a result, dummy data is activated, a margin of time until the limited-access data is invalidated by the invalidation unit 313 is extended. As a result, an adverse effect such as the limited-access data is invalidated due to erroneous password input by the rightful user may be suppressed, and thereby usability of the rightful user is improved.

Also, the count condition table 308 stores information indicating how the invalidation of the restricted-access data is performed in which access status occurs. In the example of FIG. 6B, a threshold is set for each of the number of accesses and the access duration, and the invalidation of the restricted-access data is performed through deletion. Herein, the invalidation refers to any processing for disabling the access to the restricted-access data. For example, the invalidation may also include a processing of overwriting the restricted-access data with other data. When the invalidation is performed through the deletion and/or overwrite, the restricted-access data itself does not exist in the information storage apparatus 100, and therefore the unauthorized access such as the leak and the falsification of the restricted-access data are prevented. In addition, in a case where an encryption processing is applied on the restricted-access data, the invalidation may include deletion of an encryption key. Accordingly, the decryption of the restricted-access data cannot be performed, and the unauthorized access to the restricted-access data is prevented.

(4-7) Dummy Data Generation Unit

When the instruction for the dummy data generation is received from the data switching unit 310, the dummy data generation unit 309 generates the dummy data. That is, in a case where the access to the data storage units 304 and 305 exists, the authentication result is “NG”, and also the switching to the dummy data is valid, the dummy data generation unit 309 receives the instruction for the dummy data generation from the data switching unit 310. When this instruction is received, the dummy data generation unit 309 refers to the dummy data generation method in the data switching table 307 to generate the dummy data and stores the dummy data in the specified dummy data area. At this time, the dummy data generation unit 309 may associate the address of the dummy data area 100b with the address of the restricted-access area 100a. For example, the address of the address spaces Xla to Xlf for the dummy data area 100b and the address of the address spaces Y1 to Y2 for the restricted-access area 100a are associated with each other by a 1:1 ratio. However, such association does not necessarily need to be performed.

As described above, the dummy data generation unit 309 generates the dummy data as needed in response to the instruction for the dummy data generation, and the storage capacity is reduced as compared with the case in which the dummy data storage unit 305 stores the dummy data in advance.

It should be noted that the dummy data generation unit 309 may receive the command from the transmission and reception unit 301 and refer to the data switching table 307 and the authentication result storage unit 303 to generate the dummy data instead of generating the dummy data on the basis of the instruction of the data switching unit 310. For example, when it is determined that the access to the data storage units 304 and 305 exists, the authentication result is “NG”, and also the switching to the dummy data is valid, the dummy data generation unit 309 generates the dummy data.

Also, the dummy data generation unit 309 may previously generate the dummy data at the time of installment of an OS or the like instead of depending on the instruction.

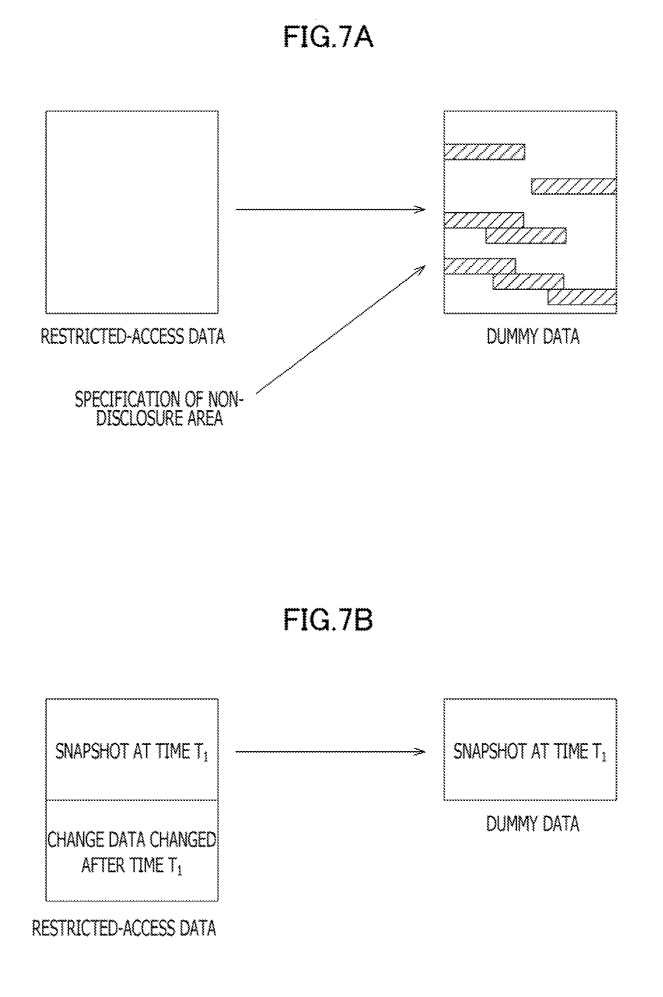

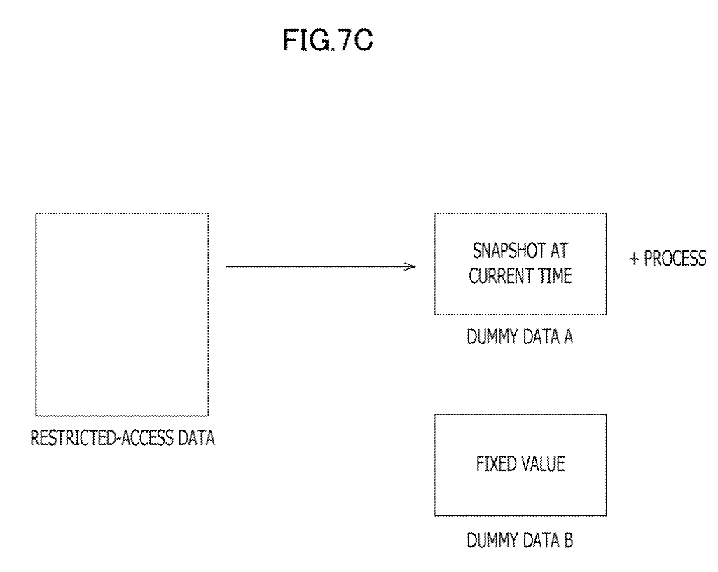

FIG. 7A, FIG. 7B, and FIG. 7C are explanatory diagrams for describing examples of the dummy data generation method. Although the generation method for the dummy data is not particularly limited, for example, the dummy data is generated through a generation method in modes 1 to 3 shown in FIG. 7A, FIG. 7B, and FIG. 7C.

According to the generation method in the mode 1 shown in FIG. 7A, the dummy data generation unit 309 may accept a specification of a non-disclosure area among the restricted-access area 100a from the user of the host apparatus 200. Also, the dummy data generation unit 309 may create, for example, a snapshot of the restricted-access data storage unit 304 to generate the dummy data through the deletion of the non-disclosure area in the created snapshot, the overwrite with other data, or the like. It should be noted that the specification of the non-disclosure area may not necessarily be accepted from the user, and an arbitrary area may be set as the non-disclosure area.

According to the generation method in the mode 2 shown in FIG. 7B, the dummy data generation unit 309 may generate a snapshot of the restricted-access data storage unit 304 at a time T₁ as the dummy data. The time T₁ is, for example, a time before the restricted-access data is stored such as a time immediately after the installment of the OS or the like, a time during which the restricted-access data is being created and is not yet stored, or the like. Herein, change data which is data changed after the time T₁ is added to the snapshot created at the time T₁ in the restricted-access data storage unit 304 after the time T₁. That is, the dummy data does not include the change data created after the time T₁.

According to the generation method in the mode 3 shown in FIG. 7C, the dummy data generation unit 309 may generate a snapshot of the restricted-access data storage unit 304, for example, at a time when an access to the data storage units 304 and 305 occurs and applies a process onto the snapshot to generate dummy data A. According to the generation method in the mode 3, furthermore, dummy data B filled up with fixed values is generated. Therefore, in the mode 3, it is possible to prepare the plural pieces of dummy data.

According to the above-mentioned generation method, the dummy data is generated on the basis of the data obtained by duplicating the restricted-access data storage unit 304. As the dummy data is generated on the basis of the restricted-access data, the unauthorized user may be further inhibited from realizing that the dummy data is provided as compared with the case where the dummy data is generated on the basis of new data. Stated differently, the dummy data may be better disguised thereby making it more difficult for the user to realize that the data obtained is the dummy data rather than restricted data.

Also, the dummy data generation unit 309 may not necessarily generate the dummy data, and the dummy data storage unit 305 may receive the dummy data from the host apparatus 200 and store the dummy data in advance, for example.

Also, according to the above-mentioned generation method, the dummy data is generated by duplicating the data storage units 304 and 305 by using the technique of a snapshot, but the duplication method is not limited to a snapshot. Any other suitable duplication method may be used.

In a case where the authentication by the rightful user fails, in order for the rightful user to recognize that the dummy data is provided, the information storage apparatus 100 may set a difference in the provision of the restricted-access data and the provision of the dummy data. For example, the restricted-access data may be provided on the basis of an image, sound, and the like customized by the user, whereas the dummy data may be provided on the basis of a default image, sound, and the like. As such, the rightful user would recognize the difference in the presentation using the default setting rather than the customized setting, whereas an unauthorized user would likely not detect the difference in the presentation. Also, a setting of a mouse pointer, an icon, and the like, a setting of the authentication screen, and the like may vary. Also, a setting may be carried out in which a name set by the rightful user is registered in a property of the restricted-access data, and an arbitrary name is registered in a property of the dummy data.

(4-8) Data Switching Unit

When various commands with respect to the data storage units 304 and 305 are received from the transmission and reception unit 301, the data switching unit 310 refers to the authentication result storage unit 303 and the data switching table 307 to switch between the access to the restricted-access data and the access to the dummy data.

For example, in a case where the authentication result of the authentication result storage unit 303 is “OK”, the data switching unit 310 performs read, write, or the like of the restricted-access data in the restricted-access data storage unit 304 in accordance with the command. Also, the data switching unit 310 may determine that the authentication result of the authentication result storage unit 303 is “NG” and that switching to the dummy data is “invalid” by referring to the data switching table 307. In this case, the data switching unit 310 performs read, write, or the like of the restricted-access data in the restricted-access data storage unit 304.

Still further, the data switching unit 310 may determine that the authentication result of the authentication result storage unit 303 is “NG” and the switching to the dummy data is “valid” by referring to the data switching table 307. In this case, the data switching unit 310 prohibits the access to the restricted-access data storage unit 304 and instead performs read, write, or the like of the dummy data in the dummy data storage unit 305. According to this scenario, the data switching unit 310 converts the address of the access destination to the restricted-access data storage unit 304 into an address in the dummy data storage unit 305 to access the dummy data. For example, in a case where the address of the address spaces Xla to Xlf for the dummy data area 100b and the address of the address spaces Y1 to Y2 for the restricted-access area 100a are associated with each other by a 1:1 ratio, the data switching unit 310 may perform the access in the following manner. For example, the access is made from the host apparatus 200 to an address Z of the restricted-access area 100a. In a case where the authentication succeeds, the data switching unit 310 accesses the address Z among the address spaces Y1 to Y2 of the restricted-access area 100a. On the other hand, in a case where the authentication fails, the data switching unit 310 switches the access to an address Z′ corresponding to the address Z among the address spaces Xla to Xlf of the dummy data area 100b. It should be noted that the address association method is not limited as long as the access can be made to the dummy data. For example, when an access to an address in the restricted-access area 100a occurs, for example, on the basis of an arbitrary address of the dummy data area 100b, the data switching unit 310 may access the dummy data.

Also, in a case where the authentication result is “NG”, the access to the data storage units 304 and 305 exists, and the switching to the dummy data is “valid”, the data switching unit 310 instructs the dummy data generation unit 309 to generate the dummy data.

Also, in a case where the authentication result is “NG” and the access is switched to the dummy data storage unit 305, the data switching unit 310 outputs the address representing the access destination to the dummy data storage unit 305 to an access count unit 311.

(4-9) Access Count Unit, Count Result Storage Unit

When the access destination to the dummy data storage unit 305 is received from the data switching unit 310, the access count unit 311 refers to the count condition table 308 and obtains the access status. For example, in a case where the address of the access destination to the dummy data storage unit 305 is included in the count area, the access count unit 311 obtains the access status. For example, in a case where the address of the access destination is included in the count area A of the start address Xla to the end address Xlb, the access count unit 311 obtains the access status.

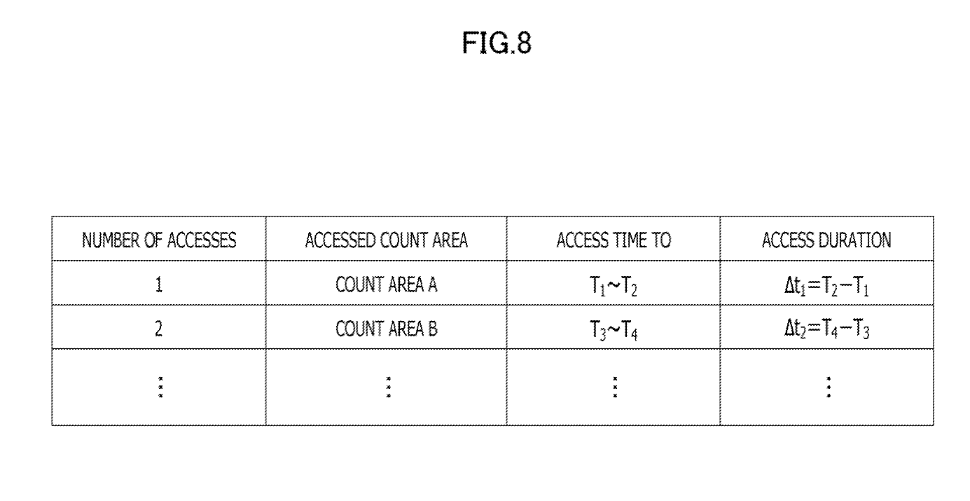

FIG. 8 shows an example of a count result storage unit. The access count unit 311 outputs the obtained access status to a count result storage unit 312 for storage. As shown in FIG. 8, the count result storage unit 312 stores the access status such as, for example, the number of accesses, the accessed count area, the access time, and the access duration.

Furthermore, the access count unit 311 refers to the count result storage unit 312 and the count condition table 308 to instruct the invalidation unit 313 to invalidate the restricted-access data. For example, when the number of accesses of the count result storage unit 312 is equal to or larger than a threshold of the number of accesses in the count condition table 308 shown in FIG. 6B, the access count unit 311 instructs the invalidation unit 313 to invalidate the restricted-access data through the set invalidation method. At this time, when the access status is equal to or larger than the threshold, the access count unit 311 sets an invalidation flag as 1 (the invalidation flag=1).

Also, the data in the count result storage unit 312 is held after various processing are ended through turning OFF the power supply of the information storage apparatus 100 or the like. However, in a case where the authentication result in the authentication processing unit 302 is “OK” at the next activation, the access count unit 311 may reset the data in the count result storage unit 312.

(4-10) Invalidation Unit

The invalidation unit 313 invalidates the restricted-access data on the basis of the specification from the access count unit 311. For example, in the case of FIG. 6B, the invalidation unit 313 invalidates the restricted-access data by deleting the restricted-access data. The invalidation unit 313 sets the invalidation flag as 0 when the invalidation is completed (the invalidation flag=0).

(5) Processing Flow

(5-1) Overall Processing

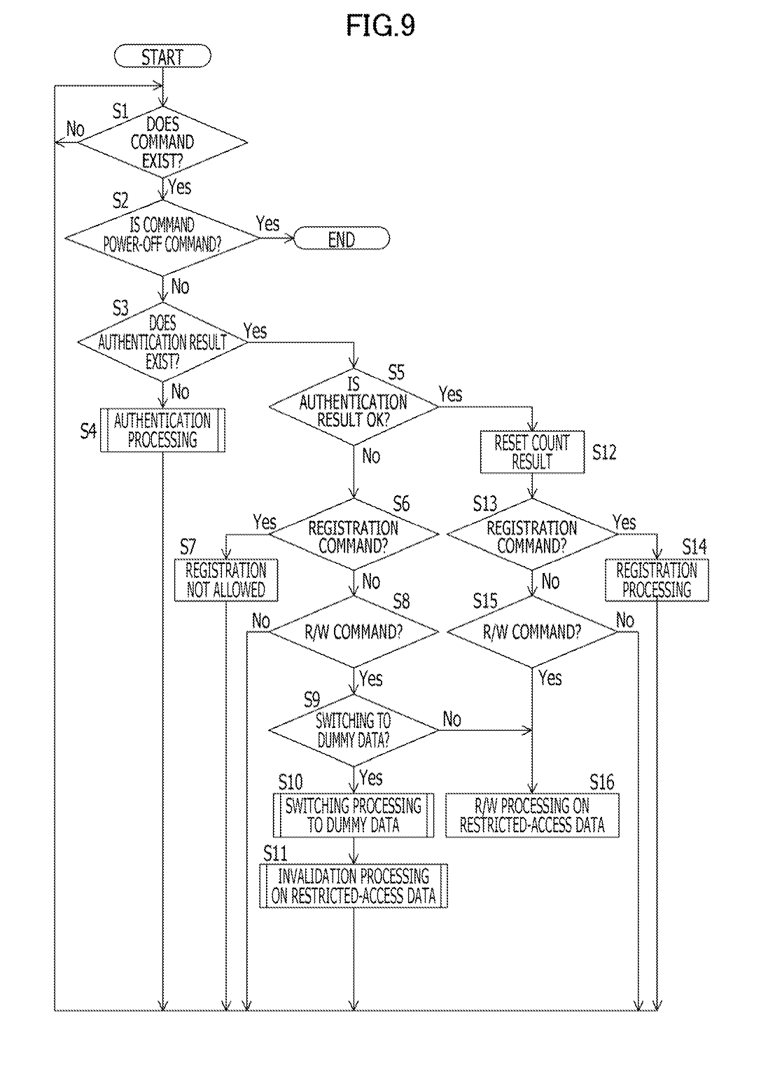

FIG. 9 is a flow chart showing a flow example of an overall processing executed by the information storage apparatus.

Operations S1 and S2: the transmission and reception unit 301 stands by for a command from the host apparatus 200 (51). When the transmission and reception unit 301 receives the command, the processing advances to operation S2, and when the command is a command for turning OFF the power supply, the processing is ended by resetting the authentication result of the authentication result storage unit 303 or the like (S2).

Operation S3: the authentication processing unit 302 determines whether or not the authentication result is stored in the authentication result storage unit 303. In a case where the authentication result is stored, the processing advances to operation S5.

Operation S4: in a case where the authentication result is not stored in the authentication result storage unit 303, the authentication processing unit 302 performs an authentication processing which will be described below.

Operation S5: in a case where the authentication result in the authentication result storage unit 303 is “NG”, the processing advances to operation S6, and in a case where the authentication result is “OK”, the processing advances to operation S12.

Operations S6 and S7: in a case where the authentication result is “NG” (S5), even when the command from the host apparatus 200 is the registration command (S6), the registration unit 306 does not perform the registration processing (S7).

Operation S8: when the data switching unit 310 receives commands with respect to the data storage units 304 and 305 such as the read command and the write command (R/W command), the processing advances to operation S9.

Operation S9: in a case where the data switching unit 310 determines that the authentication result is “NG” (S5) and the switching to the dummy data is “valid” by referring to the data switching table 307, the processing advances to operation S10. Even when the authentication result is “NG”, in a case where the switching to the dummy data is “invalid” in the data switching table 307, the processing advances to operation S16.

Operation S10: the data switching unit 310 and the dummy data generation unit 309 execute a switching processing to the dummy data which will be described below.

Operation S11: the invalidation unit 313 performs an invalidation processing on the restricted-access data in accordance with the access status.

Operation S12: in a case where the authentication result is “OK” (S5), the access count unit 311 resets the data in the count result storage unit 312 and sets the invalidation flag as 0 (the invalidation flag=0).

Operations S13 and S14: in a case where the authentication result is “OK” (S5), when the registration command is received (S13), the registration unit 306 performs the registration processing on the data switching table 307, the count condition table 308, and the like (S14).

Operation S15: when the transmission and reception unit 301 receives the read command, the write command, and the like, the processing advances to operation S16.

Operation S16: in a case where the authentication result is “OK” (S5), the data switching unit 310 receives the read command and the write command from the transmission and reception unit 301. The data switching unit 310 accesses the restricted-access data storage unit 304 in accordance with the command and performs read, write, and the like of the restricted-access data.

(5-2) Authentication Processing

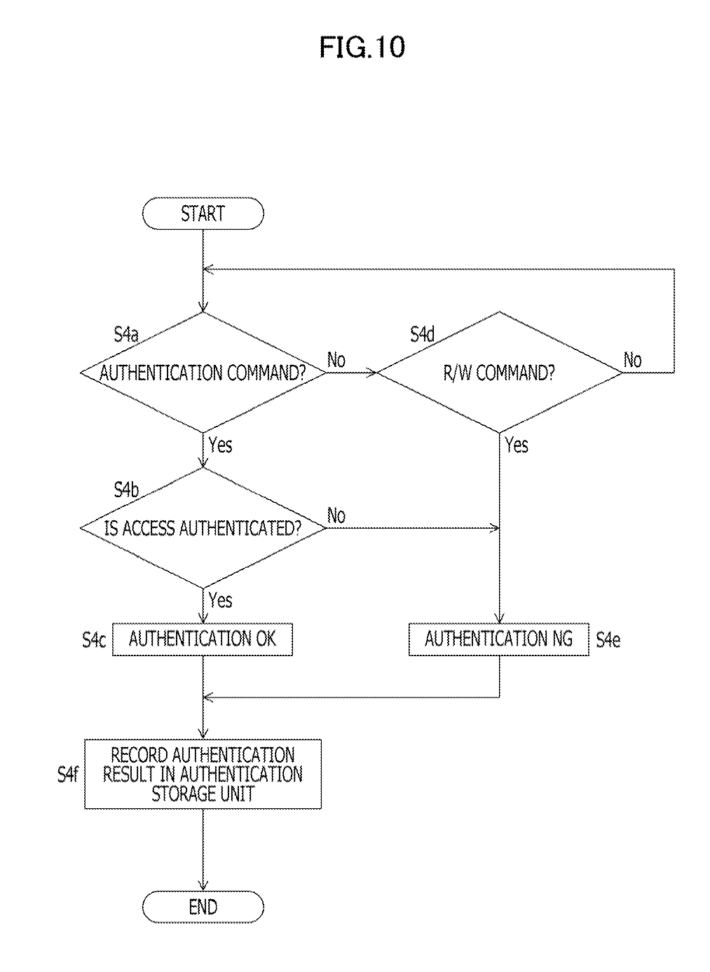

FIG. 10 is a flow chart showing a flow example of the authentication processing.

Operations S4a and S4b: when the authentication command is received (S4a), the authentication processing unit 302 compares the password input by the user with the previously stored authentication password to determine whether or not the access from the host apparatus 200 is authenticated (S4b). In the host apparatus 200, the authentication command includes the password input by the user. In a case where the password input by the user matches the authentication password, the processing advances to operation S4c. In a case where the password input by the user does not match the authentication password, the processing advances to operation S4e.

Operation S4c: in a case where the password input by the user matches the authentication password, the authentication processing unit 302 authenticates the access from the host apparatus 200.

Operations S4d and S4e: when the read command and the write command other than the authentication command are received (S4d), the authentication processing unit 302 does not authenticate the access from the host apparatus 200 (S4e). Also, in a case where the password input by the user does not match with the authentication password, the authentication processing unit 302 does not authenticate the access from the host apparatus 200 (S4e).

Operation S4f: the authentication processing unit 302 records the authentication result in the authentication result storage unit 303. The authentication result storage unit 303 holds the authentication result, for example, until the power supply is turned OFF.

(5-3) Switching Processing to Dummy Data

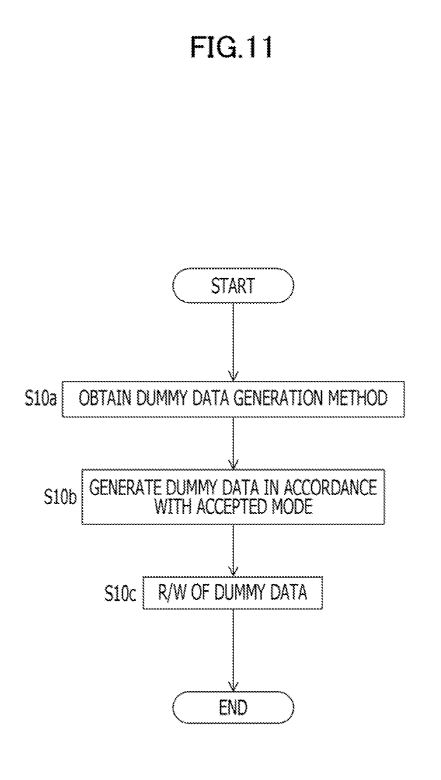

FIG. 11 is a flow chart showing a flow example of the switching processing to the dummy data.

Operation S10a: in a case where the switching to the dummy data is performed, the data switching unit 310 instructs the dummy data generation unit 309 to generate the dummy data. When the instruction for the dummy data generation is received, the dummy data generation unit 309 obtains the dummy data generation method, the specification of the dummy data area, and the like from the data switching table 307.

Operation S10b: next, the dummy data generation unit 309 generates the dummy data on the basis of the dummy data generation method and stores the dummy data in the dummy data storage unit 305 on the basis of the specified dummy data area.

Operation S10c: the data switching unit 310 accesses the dummy data storage unit 305 and performs read, write, and the like of the dummy data in accordance with the command.

(5-4) Invalidation Processing on Restricted-Access Data

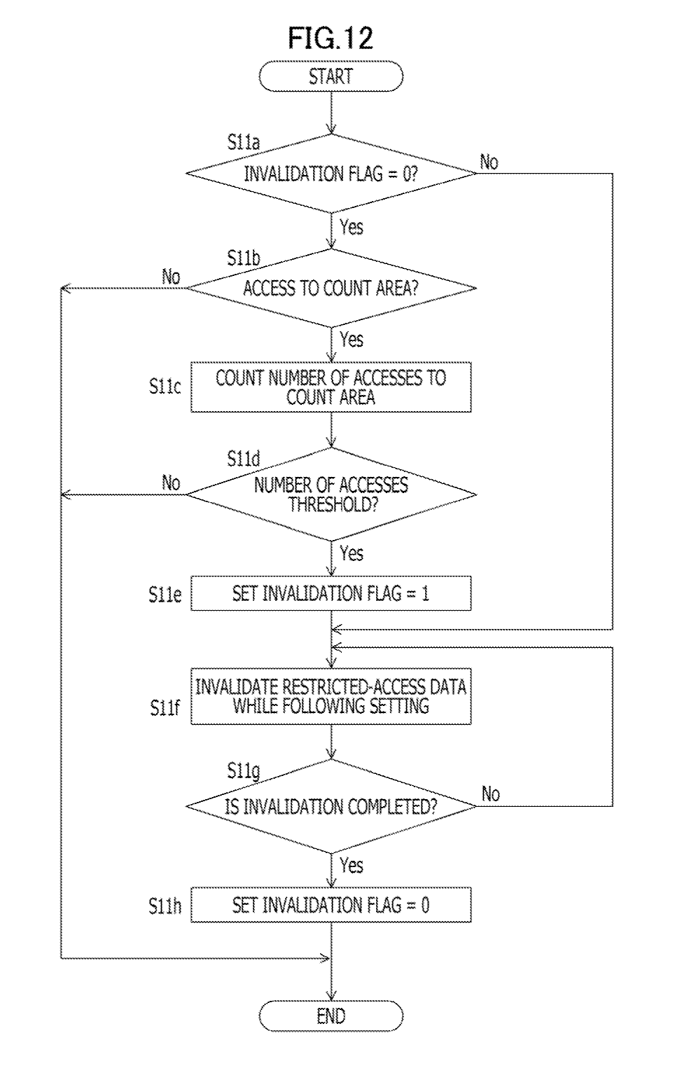

FIG. 12 is a flow chart showing a flow example of an invalidation processing on the restricted-access data.

Operation S11a: in a case where the invalidation flag is 1, as the invalidation of the restricted-access data is in progress, the processing advances to operation S11f, and the invalidation unit 313 continues the invalidation. In a case where the invalidation flag is 0, the processing advances to operation S11b.

Operation S11b: the access count unit 311 receives the access destination to the dummy data storage unit 305 from the data switching unit 310 and refers to the count condition table 308 to determine whether or not the access destination is included in the count area. In a case where the access destination is included in the count area, the processing advances to operation S11c, and in a case where the access destination is not included, the processing is ended.

Operation S11c: in a case where the access destination is included in the count area, for example, the access count unit 311 counts the number of accesses to be recorded in the count result storage unit 312.

Operations S11d and S11e: when, for example, the access count unit 311 counts up and the number of accesses of the count result storage unit 312 becomes equal to or larger than the threshold, the access count unit 311 sets the invalidation flag as 1. Furthermore, the access count unit 311 instructs the invalidation unit 313 to perform the invalidation of the restricted-access data through the invalidation method set in the count condition table 308. On the other hand, for example, in a case where the number of accesses is smaller less than the threshold, the processing is ended.

Operations S11f and S11g: the invalidation unit 313 performs the invalidation of the restricted-access data while following the set invalidation method. When the invalidation is completed, the processing advances to operation S11h. In a case where the invalidation is not completed, the processing returns to operation S11f, and the invalidation unit 313 continues the invalidation.

Operation S11h: when the invalidation is completed, the invalidation unit 313 sets the invalidation flag as 0 (the invalidation flag=0).

(6) Setting Example of Count Area Based on ATA Standard

In a case where a communication based on TCG (Trusted Computing Group) storage compliant specification in ATA standard is performed between the information storage apparatus 100 and the host apparatus 200, for example, various settings are carried out in the following manner.

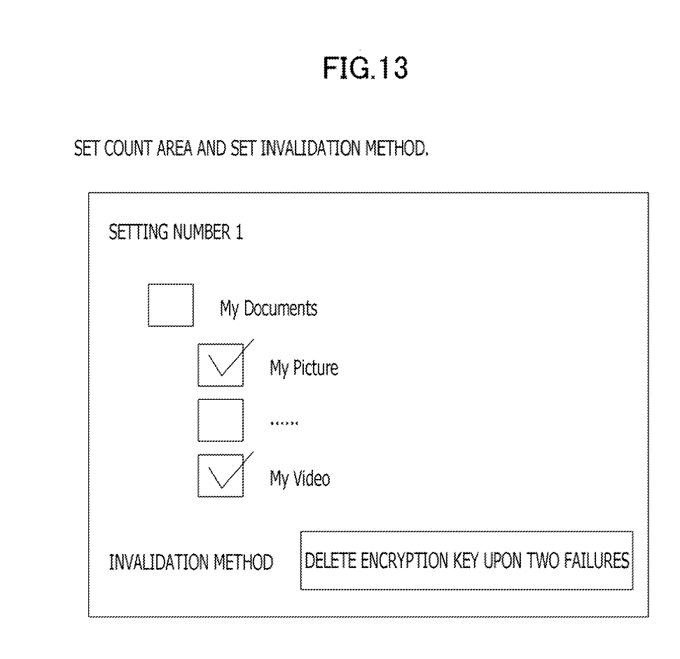

The host apparatus 200 reads an application for setting the data switching table 307 and the count condition table 308 in the information storage apparatus 100 to be executed by the CPU 201. The host apparatus 200 displays a screen for setting the data switching table 307 and the count condition table 308 on the display 208. For example, the screen for setting the count condition table 308 is displayed as shown in FIG. 13.

FIG. 13 shows a screen example for setting the count condition table which is displayed on a display of the host apparatus. In the screen example of FIG. 13, the user is instructed to set the count area and the invalidation method for the restricted-access data. In response to this, the user specifies files of “My picture” and “My Video” as the count areas and specifies that the encryption key is deleted upon the occurrence of two failed access attempts.

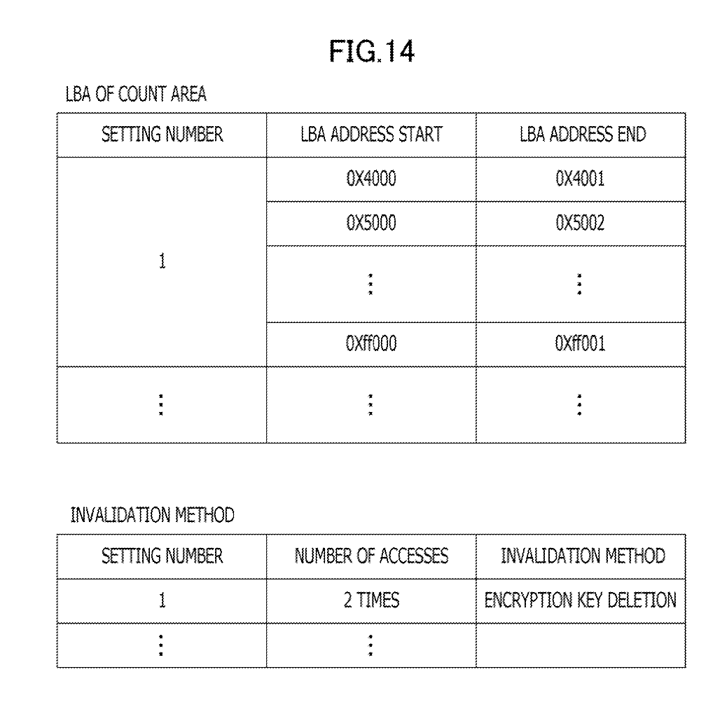

The CPU 201 of the host apparatus 200 generates the registration command based on the setting by the user through the execution of the application and outputs the registration command to the information storage apparatus 100. FIG. 14 shows an example of information included in the registration command for setting the count area and an invalidation method. On the files specified as the count areas, the CPU 201 of the host apparatus 200 calculates an LBA (Logical Block Addressing) address in the information storage apparatus 100. The registration command shown in FIG. 14 includes information such as the start and the end of the LBA address, the number of accesses, and the invalidation method based on the screen example for each setting number. In addition, the host apparatus 200 generates the registration command with regard to the specifications such as the switching to the dummy data, the generation method for the dummy data, and the dummy data area and transmits the registration command to the information storage apparatus 100.

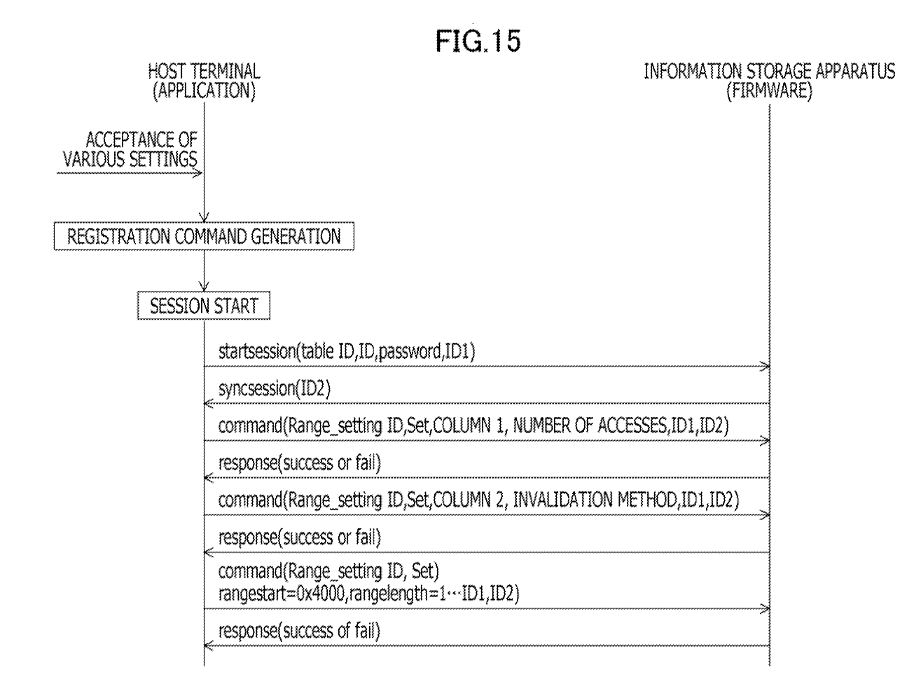

FIG. 15 is a flow chart showing a flow example of a setting processing for the data switching table and the count condition table. The host apparatus 200 accepts various settings for the data switching table 307 and the count condition table 308 from the user. Next, on the basis of the accepted settings, the host apparatus 200 generates the registration command and starts a session with the information storage apparatus 100. For example, in the first session, the host apparatus 200 transmits startsession including a table ID for a table to be set, an ID and a password having an access right to the table, and ID1 which is a session ID to the information storage apparatus 100. Next, in response to the reception of the startsession from the host apparatus 200, the information storage apparatus 100 transmits syncsession including ID2 which is a session ID to the host apparatus 200. Furthermore, the host apparatus 200 transmits a command for setting the count area, the invalidation method, and the like to the information storage apparatus 100. With this command, the specification is made on what is set in which section in the table. For example, the command includes Range_setting ID for identifying the respective settings, an order that should be processed such as Set, a specification of a write location such as column 1, a content that should be written such as the number of accesses, a session ID, and the like.

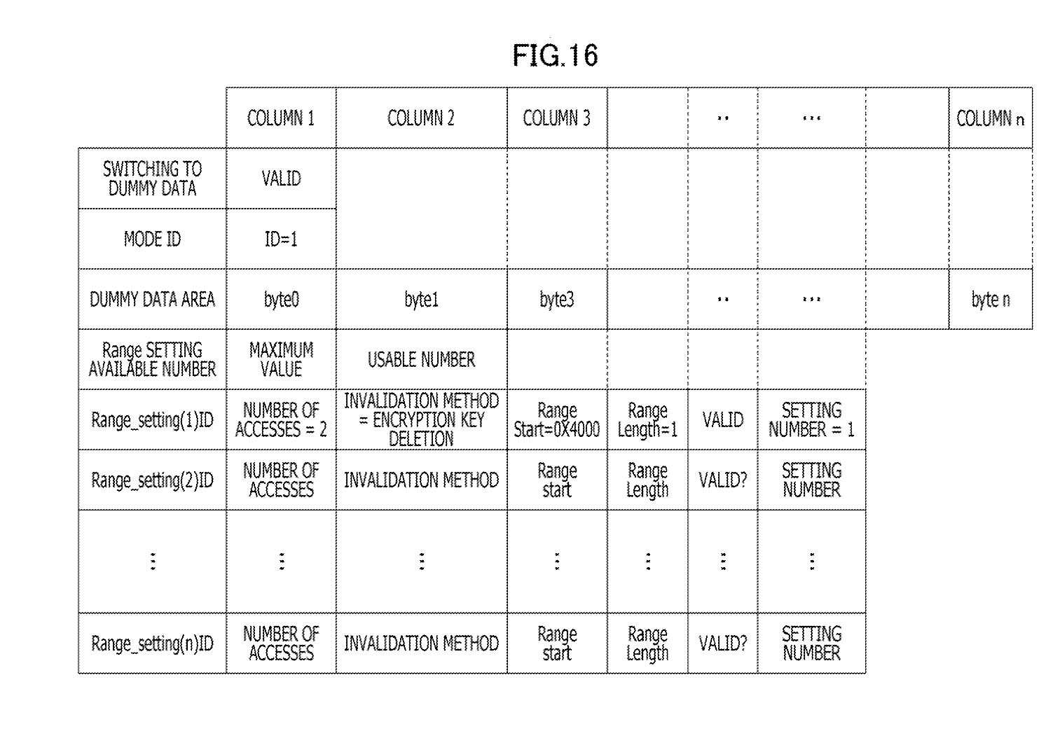

FIG. 16 shows examples of the data switching table and the count condition table. When the processing for setting the data switching table 307 and the count condition table 308 is completed between the host apparatus 200 and the information storage apparatus 100, for example, the table shown in FIG. 16 is generated.

### (7) Modified Examples

### (a) First Modified Example

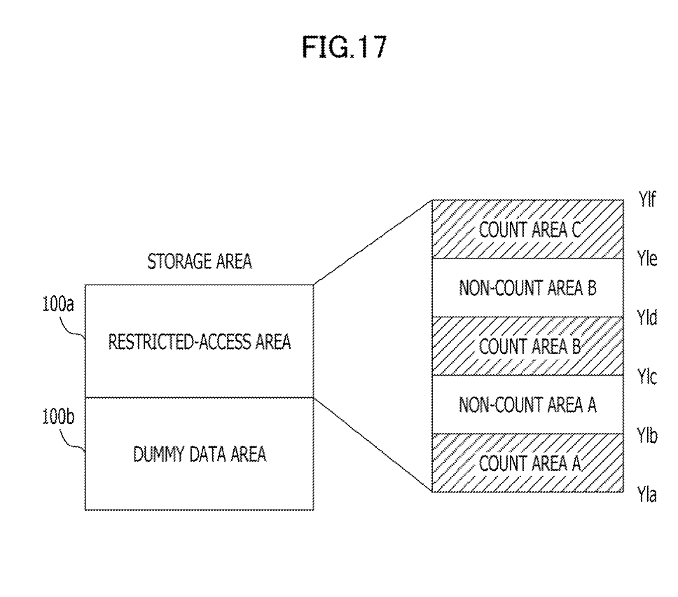

According to the above-mentioned embodiment example, the count area and the non-count area are provided in the dummy data area 100b. However, as shown in FIG. 17, the count area and the non-count area may be provided in the restricted-access area 100a.

FIG. 17 is an explanatory diagram of a storage area of an information storage apparatus according to the present modified example. In this case, for example, the following processing is performed. It should be noted that in the count condition table 308, on the basis of the registration command, it is supposed that the count areas A, B, and C are set in the restricted-access area 100a by the start address and the end address. For example, the start address of the count area A is “Y1a”, and the end address is “Y1b”.

It is supposed that the data switching unit 310 determines that the authentication result of the authentication result storage unit 303 is “NG” and the switching to the dummy data is “valid” by referring to the data switching table 307. In this case, the data switching unit 310 prohibits access to the restricted-access data storage unit 304, and instead, read, write, and the like of the dummy data is performed in the dummy data storage unit 305. The dummy data switching unit 310 outputs the address of the restricted-access area 100a to which the access is made from the host apparatus 200 to the access count unit 311. In a case where the address of the restricted-access area 100a is included in the count area set in the count condition table 308, the access count unit 311 obtains the access status. Processing after this are the same as the above-mentioned processing, and when the number of accesses the count area in the restricted-access area 100a or the like reaches the threshold, the invalidation unit 313 performs the invalidation of the restricted-access data.

(b) Second Modified Example

In the above description, the information storage apparatus 100 performs the switching between the restricted-access data and the dummy data on the basis of the authentication result of the authentication result storage unit 303 and the data switching table 307. However, the information storage apparatus 100 may perform the switching between the restricted-access data and the dummy data by referring to only the authentication result of the authentication result storage unit 303. According to this scenario, the data switching unit 310 refers to only the authentication result storage unit 303 and performs read, write, or the like of the restricted-access data in the restricted-access data storage unit 304 in a case where the authentication succeeds. On the other hand, in a case where the authentication fails, the data switching unit 310 prohibits the access to the restricted-access data storage unit 304, and read, write, or the like of the dummy data is performed in the dummy data storage unit 305. Furthermore, in a case where the authentication fails, the data switching unit 310 instructs the dummy data generation unit 309 to generate the dummy data.

Accordingly, the information storage apparatus 100 may not necessarily set the validation or invalidation of the switching processing to the dummy data in the data switching table 307.

(8) Operation Effect

In a case where the authentication succeeds, the information storage apparatus 100 permits the access from the host apparatus 200 to the storage unit. Therefore, the host apparatus 200 can access the restricted-access area 100a where the access is restricted. However, in a case where the authentication fails, the information storage apparatus 100 switches the access to the dummy data area 100b where the dummy data is stored. Therefore, the host apparatus 200 which is not authenticated is prevented from accessing the restricted-access area 100a.

Even in a case where the authentication fails, the host apparatus 200 is not necessarily denied access to the storage unit. For example, the access to the dummy data area 100b may be made. Accordingly, the user of the host apparatus 200 does not necessarily receive the impression that the authentication failed. As a result, the host apparatus 200 accesses the information storage apparatus 100. The information storage apparatus 100 counts the number of accesses. When the number of accesses exceeds the threshold, the invalidation unit 313 executes invalidation of the limited-access data. Accordingly, the restricted-access data may be protected from the unauthorized accesses such as the leak, the falsification, the exploitation through damage or destruction of the information storage apparatus 100.

In the case of the access from the host apparatus 200 which is not authenticated, the information storage apparatus 100 obtains the access status only with regard to the count area, and when this access status reaches the threshold, the restricted-access data is invalidated. Even the rightful user may fail the authentication in some cases through an input error of a password used for the authentication or the like. As described above, limiting an area to monitor an access status generates an area the access status of which is not counted, thereby extending time until the number of accesses reaches the threshold for the length of time generated by not-counting the area. Accordingly, compared with the case where access statuses of all areas are monitored, time until invalidation processing is executed is extended even with substantially the same threshold. Moreover, time until invalidation processing is executed is extended compared with the case where an area of the storage unit is immediately invalidated when the authentication fails. As described above, extending time from authentication failure to invalidation provides a margin of time, in other words, an extra time to the user. Thus, usability for the rightful user is improved. By exemplifying a more specific example, the description will be given next.

When the authentication fails by even the rightful user through an erroneously input password, even when the access is attempted to the restricted-access data in the restricted-access area 100a from the host apparatus 200, the information storage apparatus 100 accesses the dummy data area 100b to provide the host apparatus 200 with the dummy data. However, the rightful user may grasp the state in which the authentication fails on the basis of the situation where the dummy data is provided instead of the restricted-access data. For that reason, the rightful user does not repeat the access in the state in which the authentication fails. Even if the location accessed by the host apparatus 200 is the count area and the number of accesses is counted, a possibility in which the number of accesses reaches the threshold is low. Also, if the location accessed by the host apparatus 200 is the non-count area, the number of accesses is not counted. That is, in a case where the authentication fails, the margin to reach the threshold is expanded in the case where only the access status to the count area is measured as compared with the case where the access status to all the areas is measured. In other words, by providing the non-count area which is not set as the measurement target, as compared with a case where all the areas are set as the count areas, the margin to the invalidation of the restricted-access data is expanded. Therefore, the adverse effect is suppressed in which the restricted-access data is invalidated so that the rightful user cannot access the restricted-access data in a case where the authentication by the rightful user fails, and the usability for the rightful user is improved.

On the other hand, the unauthorized access performed by the host apparatus 200 which is not authenticated is generally performed over a plurality of times with respect to all the areas in the storage area. As plural accesses to the count area are made, the number of accesses to the count area reaches the threshold. According to this, the invalidation of the restricted-access data can be effectively executed by the invalidation unit 313.

### Another Embodiment Example

(1) Outline

According to another embodiment example, another setting method for the count area is proposed. According to the above-mentioned embodiment example, the setting of the count area is performed on the basis of the specification from the rightful user who succeeds with the authentication. On the other hand, according to the following embodiment example, in a case where the authentication succeeds, the information storage apparatus 100 obtains the access status from the host apparatus and sets the count area on the basis of the access status.

(2) Functional Configuration

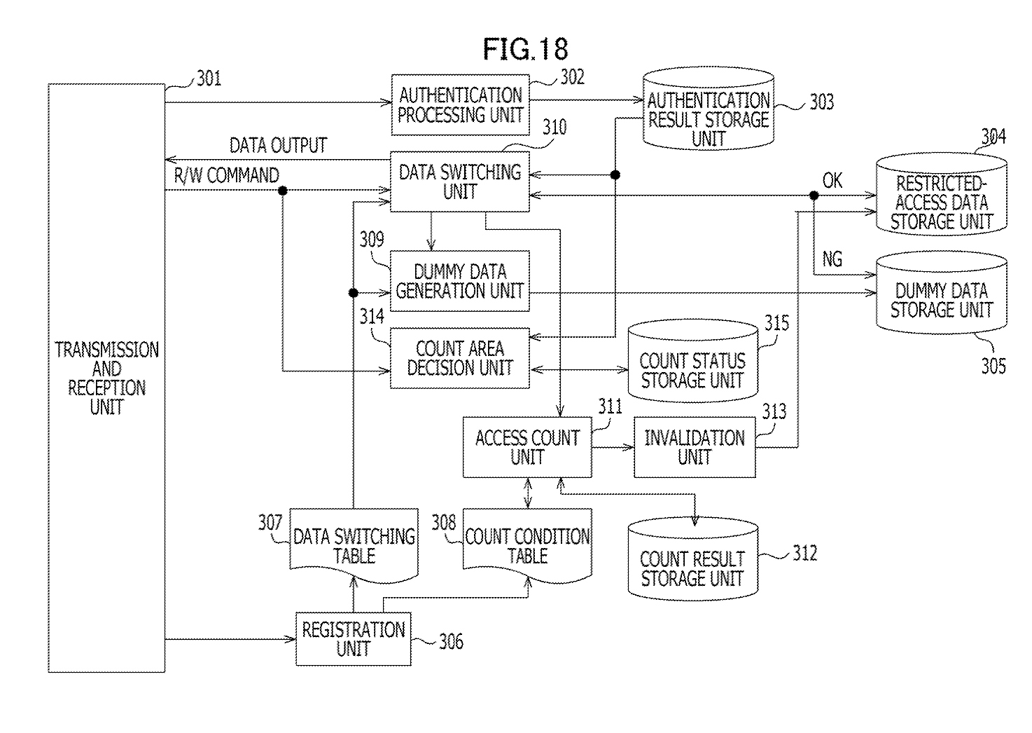

FIG. 18 is a block diagram showing a functional configuration example of the information storage apparatus. The information storage apparatus is further provided with a count area decision unit 314 and the access status storage unit 315.

When the authentication result of the authentication result storage unit 303 is “OK” and the access to the data storage units 304 and 305 exists, the count area decision unit 314 obtains the access status for each access destination. That is, the count area decision unit 314 obtains the access status by the rightful user. The count area decision unit 314 stores the obtained access status in the access status storage unit 315.

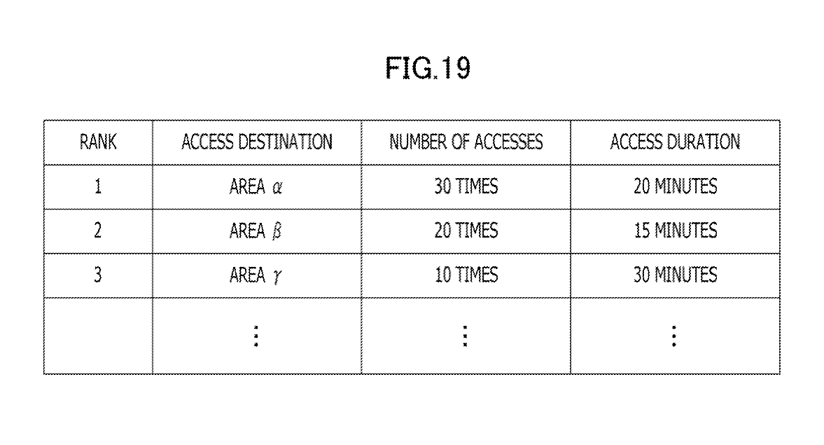

FIG. 19 shows an example of the access status storage unit. The access status storage unit 315 stores the access status such as the number of accesses and the access duration for each access destination. The count area decision unit 314 decides the count area on the basis of the access status of the access status storage unit 315. For example, the count area decision unit 314 decides the access destination where the number of accesses and/or the access duration is small as the count area. The count area decision unit 314 outputs the decided count area to the count condition table 308 for registration in operations S13 and S14 shown in FIG. 9 of the above-mentioned embodiment example. Hereinafter, a description will be given of a case where the count area is set in the dummy data area and a case where the count area is set in the restricted-access area.

(2-1) Case of Setting Count Area in Dummy Data Area

In a case where the count area is set in the dummy data area 100b, the count area decision unit 314 performs the following processing.

The count area decision unit 314 receives the read command and the write command to the restricted-access area 100a from the transmission and reception unit 301. When the command is received in a case where the authentication result of the authentication result storage unit 303 is “OK”, the access status is obtained for each access destination included in the command. The access status storage unit 315 stores the access status. For example, as shown in FIG. 19, the count area decision unit 314 rates the access destinations on the basis of the number of accesses and selects the access destination with a small number of accesses. Also, as the address of the selected access destination is an address in the restricted-access area 100a, the count area decision unit 314 converts the address of the selected access destination into an address in the dummy data area 100b. The count area decision unit 314 decides the area indicated by the converted address as the count area. The count area decision unit 314 outputs the decided count area to the count condition table 308 for registration.

In addition, the count area decision unit 314 may also decide the count area on the basis of the access destination whose number of accesses and/or the access duration is equal to or lower than a lower limit value.

It should be noted that the count area decision unit 314 may also obtain the access status for each access destination accessed by the data switching unit 310 instead of obtaining the access status on the basis of the command received from the transmission and reception unit 301.

(2-2) Case of Setting Count Area in Restricted-access Area

In the above description, the count area decision unit 314 selects the access destination whose number of accesses is small on the basis of FIG. 19. Herein, the address of the selected access destination is an address in the restricted-access area 100a. Therefore, in a case where the count area is set in the restricted-access area 100a, the count area decision unit 314 decides the address of the selected access destination as the count area as it is. As the count condition table 308 registers the address of the access destination, the count area can be set in the restricted-access area 100a.

(3) Operation Effect

According to the above-mentioned embodiment example, the count area is set on the basis of the specification from the rightful user, but according to the present embodiment example, the count area decision unit 314 decides the count area. Therefore, it is possible to save time by not requiring the user to specify the count area. Also, the count area is set on the basis of the actual access status by the rightful user. Thus, as compared with the setting by the user, it is possible to accurately set the area with an even smaller number of accesses as the count area.

Also, the count area decision unit 314 decides the access destination whose number of accesses and/or access duration is small or the access destination whose number of accesses and/or access duration is equal to or smaller than the lower limit value as the count area. Therefore, the area having the small number of accesses from the host apparatus 200 or the area having no access from the host apparatus can be accurately set as the count area.

It should be noted that as the access status regularly changes, the count area decision unit 314 may also change the count area in accordance with the change of the access status as needed. According to this, the setting of the count area in accordance with the access status can be realized. For example, the count area decision unit 314 regularly obtains the access status at the access destination and rates the count areas as needed in descending order of the number of the access destinations. Then, the count area decision unit 314 performs deletion or the like of even the count area already registered in the count condition table 308 in a case where the count area is in a high rank. Also, the count area decision unit 314 deletes the count area whose number of accesses or the like exceeds the threshold.

### Another Embodiment Example

(1) Outline

The information storage apparatus 100 according to the above-mentioned embodiment example performs the authentication processing at the time of the activation, and thereafter, each time the command is received from the host apparatus 200, the information storage apparatus 100 refers to the authentication result of the authentication result storage unit 303 to switch the access destination in accordance with the authentication result. On the other hand, the information storage apparatus 100 according to the following embodiment example refers to the authentication result of the authentication result storage unit 303 only once after the activation. After that, the information storage apparatus 100 switches the access destination on the basis of the authentication result referred to once without referring to the authentication result each time the command is received from the host apparatus 200 until the power supply is turned OFF.

(2) Functional Configuration

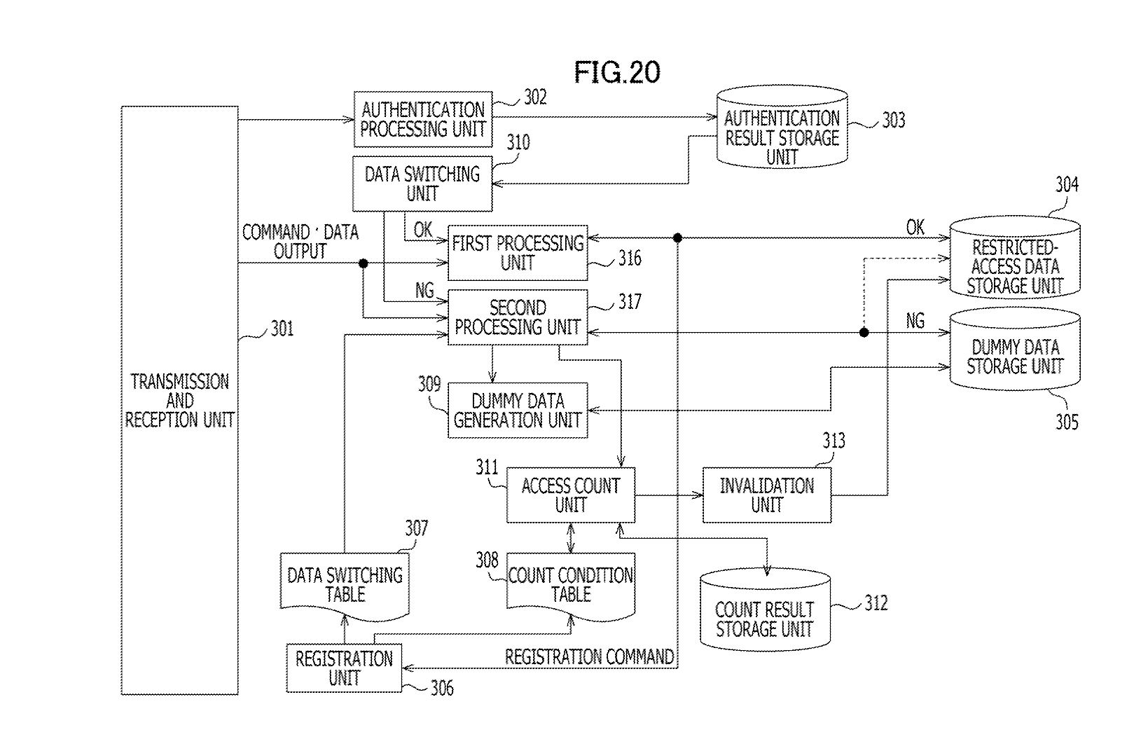

FIG. 20 is a block diagram showing a functional configuration example of the information storage apparatus. The information storage apparatus 100 is further provided with a first processing unit 316 and a second processing unit 317.

(2-1) Transmission and Reception Unit

The transmission and reception unit 301 receives various commands input from the host apparatus 200 to be transmitted to the respective units. For example, the transmission and reception unit 301 receives the authentication command from the host apparatus 200 to be output to the authentication processing unit 302. Also, the transmission and reception unit 301 outputs various commands from the host apparatus 200 such as the read command and the write command to either one of the first processing unit 316 and the second processing unit 317. Furthermore, the transmission and reception unit 301 outputs the data from the first processing unit 316 or the second processing unit 317 to the host apparatus 200.

(2-2) First Processing Unit, Second Processing Unit

The first processing unit 316 is activated in a case where the authentication succeeds and receives various commands via the transmission and reception unit 301 from the host apparatus 200. The first processing unit 316 accesses the restricted-access data storage unit 304 in accordance with the received command. For example, the first processing unit 316 accesses the relevant restricted-access data on the basis of the address of the access destination to the restricted-access data storage unit 304 included in the command. Also, when the registration command is received, the first processing unit 316 outputs the registration command to the registration unit 306.

On the other hand, the second processing unit 317 is activated in a case where the authentication fails and receives various commands via the transmission and reception unit 301 from the host apparatus 200. The second processing unit 317 accesses the dummy data storage unit 305 in accordance with the received command. At this time, the second processing unit 317 converts the address of the access destination to the restricted-access data storage unit 304 included in the command into an address in the dummy data storage unit 305 to access the dummy data. In addition, the second processing unit 317 instructs the dummy data generation unit 309 to generate the dummy data and outputs the address indicating the access destination to the dummy data storage unit 305 to the access count unit 311.

It should be noted that the second processing unit 317 may access the dummy data storage unit 305 or the restricted-access data storage unit 304 depending on whether the switching to the dummy data is “valid” or “invalid”. That is, in a case where the authentication fails and also the switching to the dummy data is “valid” in the data switching table 307, the second processing unit 317 accesses the dummy data storage unit 305. Also, the second processing unit 317 outputs the instruction to the dummy data generation unit 309 and the access count unit 311. On the other hand, in a case where the authentication fails and also the switching to the dummy data is “invalid” in the data switching table 307, the second processing unit 317 accesses the restricted-access data storage unit 304. At this time, the second processing unit 317 may not necessarily output the instruction to the dummy data generation unit 309 and the access count unit 311.

With the above-mentioned configuration, once the authentication succeeds and the first processing unit 316 is activated, until the stop of the activation of the information storage apparatus 100, the subsequent exchange of the command and the data with the host apparatus 200 is performed via the first processing unit 316. In contrast, once the authentication fails and the second processing unit 317 is activated, the subsequent exchange of the command and the data with the host apparatus 200 is performed via the second processing unit 317. That is, in accordance with the authentication result, only one of the first processing unit 316 and the second processing unit 317 is activated, and the subsequent processing is performed via the one of the processing units in accordance with the authentication result. Therefore, each time the command and the like are received from the host apparatus 200, the information storage apparatus 100 may not necessarily refer to the authentication result storage unit 303. For that reason, the time used for the access processing accompanied by the access from the host apparatus 200 is reduced.

(2-3) Data Switching Unit

The data switching unit 310 refers to the authentication result storage unit 303 to activate either one of the first processing unit 316 and the second processing unit 317. For example, in a case where the authentication result of the authentication result storage unit 303 is “OK”, the data switching unit 310 activates the first processing unit 316. On the other hand, in a case where the authentication result of the authentication result storage unit 303 is “NG”, the data switching unit 310 activates the second processing unit 317.

(2-4) Registration Unit

When the registration command is received from the first processing unit 316, the registration unit 306 accepts a rewrite request of the firmware included in the registration command the registration command, and on the basis of the registration command, the registration processing in the respective conditions is performed on the data switching table 307, the count condition table 308, and the like.

(2-5) Dummy Data Generation Unit

When the instruction for the dummy data generation is received from the second processing unit 317, the dummy data generation unit 309 generates the dummy data.

(2-6) Access Count Unit, Count Result Storage Unit

When the access destination to the dummy data storage unit 305 is received from the second processing unit 317, the access count unit 311 refers to the count condition table 308 to obtain the access status. For example, the access count unit 311 obtains the access status in a case where the address of the access destination to the dummy data storage unit 305 is included in the count area.

(3) Processing Flow

Once the information storage apparatus 100 refers to the authentication result, until the information storage apparatus 100 is activated again, the information storage apparatus 100 does not refer to the authentication result. Therefore, hereinafter, a description will be given of a processing flow.

(3-1) Overall Processing

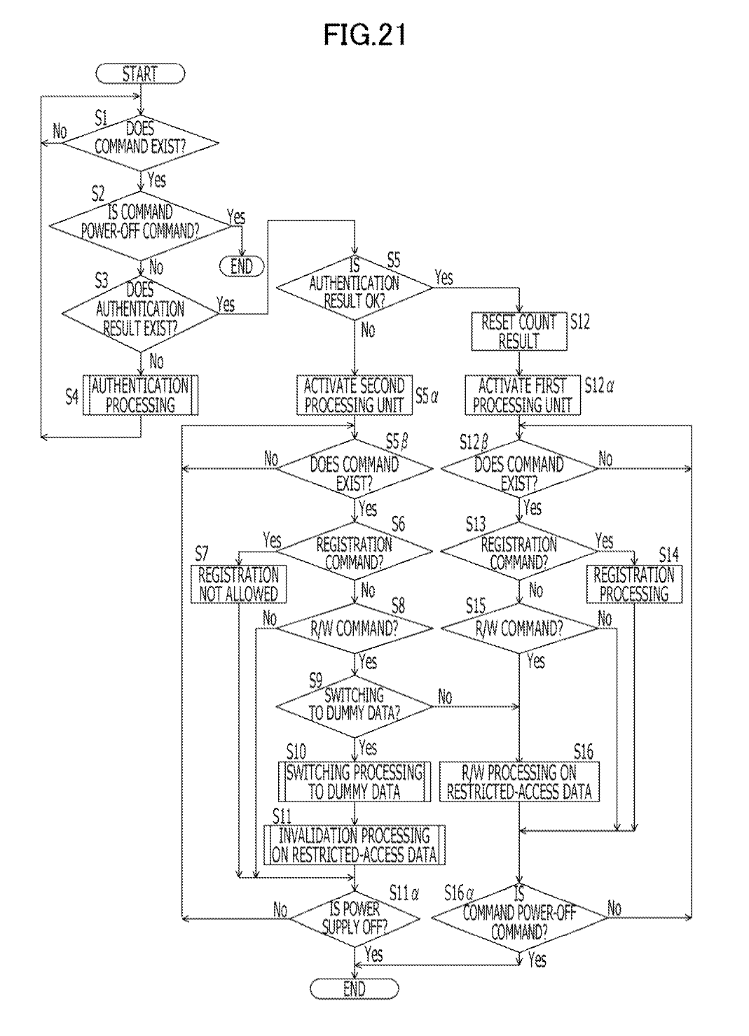

FIG. 21 is a flow chart showing a flow example of an overall processing executed by the information storage apparatus.

Operations S1 to S4: the information storage apparatus 100 performs the authentication processing in accordance with the presence or absence of the authentication result.

Operation S5: the data switching unit 310 determines whether the authentication result of the authentication result storage unit 303 is “OK” or “NG”.

Operation S5α: the data switching unit 310 activates the second processing unit 317 in a case where the authentication result is “NG”.

Operation S5β: the second processing unit 317 stands by for the command from the host apparatus 200.

Operations S6 and S7: in a case where the authentication result is “NG”, even when the second processing unit 317 receives the registration command (S6), the registration unit 306 does not perform the registration processing (S7).

Operation S8: when the second processing unit 317 receives commands to the data storage units 304 and 305 such as the read command and the write command (R/W command), the processing advances to operation S9.

Operation S9: in a case where the second processing unit 317 determines that the switching to the dummy data is “valid” by referring to the data switching table 307, the processing advances to operation S10. Even when the authentication result is “NG”, in a case where the switching to the dummy data is “invalid” in the data switching table 307, the processing advances to operation S16.

Operation S10: the second processing unit 317 and the dummy data generation unit 309 execute a switching processing to the dummy data which will be described below.

Operation S11: the invalidation unit 313 performs the invalidation processing of the restricted-access data in accordance with the access status.

Operation S11a: the second processing unit 317 receives the command for turning OFF the power supply, and the processing is ended.

Operation S12: in a case where the authentication result is “OK” (S5), the access count unit 311 resets the data in the count result storage unit 312 and sets the invalidation flag as 0 (the invalidation flag=0).

Operation S12α: in a case where the authentication result is “OK”, the data switching unit 310 activates the first processing unit 316.

Operation S12β: the first processing unit 316 stands by for the command from the host apparatus 200.

Operations S13 and S14: in a case where the authentication result is “OK”, when the first processing unit 316 receives the registration command (S13), the registration unit 306 performs the registration processing on the data switching table 307, the count condition table 308, and the like (S14).

Operation S15: when the first processing unit 316 receives the read command, the write command, and the like, the processing advances to operation S16.

Operation S16: the first processing unit 316 accesses the restricted-access data storage unit 304 in accordance with the command received in operation S15 and performs read, write, or the like of the restricted-access data. Alternatively, in a case where the switching to the dummy data is “invalid” (S9), the second processing unit 317 accesses the restricted-access data storage unit 304 in accordance with the command.

Operation S16α: the first processing unit 316 receives the command for turning OFF the power supply, and the processing is ended.

(3-2) Other Respective Processing

The authentication processing (S4) and the invalidation processing of the restricted-access data (S11) are similar to those of the above-mentioned embodiment example. Also, with regard to the switching processing to the dummy data (S10), a main body for the generation instruction of the dummy data and the access to the dummy data storage unit 305 is the second processing unit 317.

(4) Operation Effect

In accordance with the success or failure of the authentication, either one of the first processing unit 316 and the second processing unit 317 is activated, and thereafter, until the activation of the information storage apparatus 100 stops, the activated processing unit performs the transmission and reception of the command, the data, and the like with the host apparatus 200. Therefore, each time the command and the like are received from the host apparatus 200, the information storage apparatus 100 may not necessarily refer to the authentication result storage unit 303, and the time used for the access processing accompanied by the access from the host apparatus is reduced as a whole. It should be noted that it is not necessary to provide the first processing unit 316 and the second processing unit 317 described above. For example, the data switching unit 310 may refer to the authentication result of the authentication result storage unit 303 only once and switch the access destination with respect to the commands received a plurality of times on the basis of the authentication result that is only referred once, for example.

### Other Embodiment Examples

### (a) First Modified Example

According to the above-mentioned embodiment example, the authentication processing unit 302 of the information storage apparatus 100 compares the password input by the user with the authentication command to perform the authentication processing. Herein, the password used for the authentication processing is not limited to the password input by the user.

For example, the authentication password may be previously registered between the BIOS in the flash memory 205 of the host apparatus 200 and the information storage apparatus 100. For example, the authentication processing unit 302 registers the apparatus password making it possible to identify each host apparatus 200 as the authentication password. In this case, the authentication processing may be performed in the following manner. For example, the CPU 201 of the host apparatus 200 reads out the BIOS in the flash memory 205 to transmit the apparatus password to the information storage apparatus 100. The authentication processing unit 302 of the information storage apparatus 100 compares the apparatus password with the authentication password to perform the authentication processing. According to this, transmission and reception of the data and the command may be permitted only between the host apparatus 200 where the registration of the authentication password is performed and the information storage apparatus 100, for example.

Also, a plurality of authentication passwords may be set as will be described next.

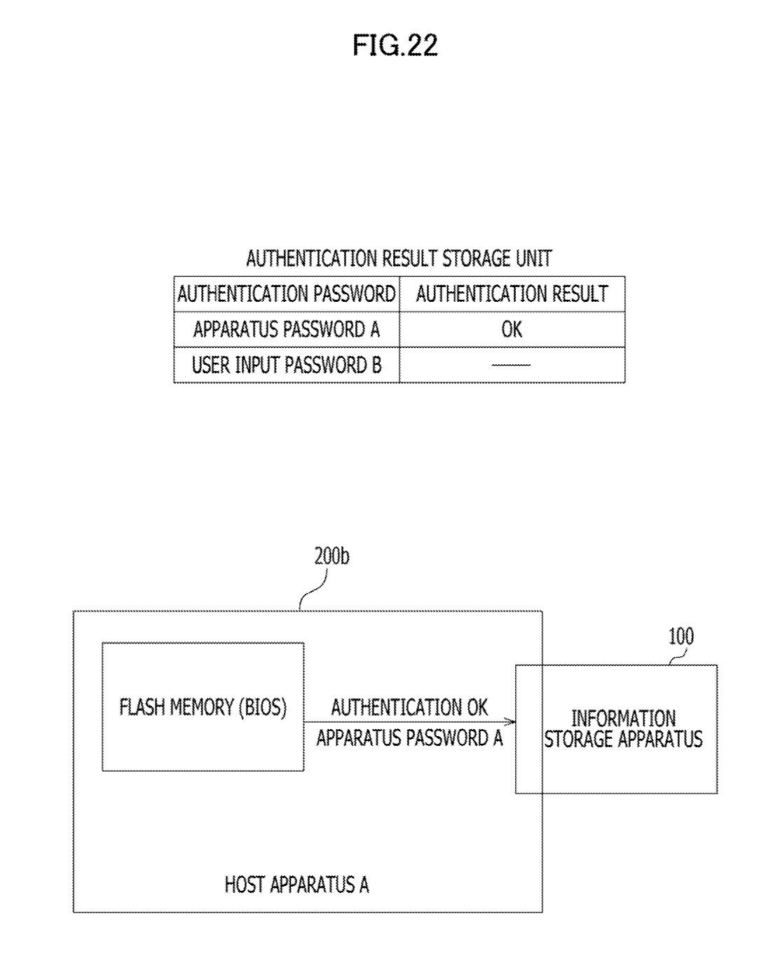

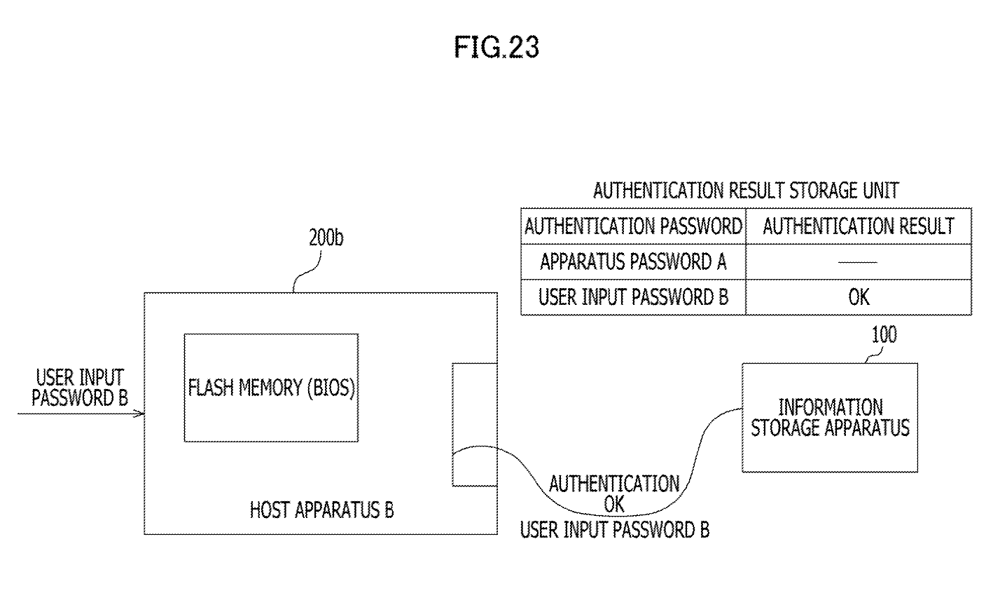

FIG. 22 and FIG. 23 are schematic diagrams for describing the authentication processing in a case where a plurality of authentication passwords are set. For example, as shown in FIG. 22, the authentication processing unit 302 of a host apparatus A registers the apparatus password A and a user input password B that should be input by the user. According to the present modified example, the authentication processing unit 302 permits the access to the information storage apparatus 100 when the authentication succeeds on the basis of either one of the apparatus password A and the user input password B. Also, as the apparatus password A is transmitted to the information storage apparatus 100 by the execution of BIOS by the CPU 201 of the host apparatus A, the authentication processing by the apparatus password A is performed prior to the authentication processing based on the user input password B.

Herein, when the host apparatus A is connected to the information storage apparatus 100 as shown in FIG. 22, the CPU 201 of the host apparatus A executes the BIOS to transmit the apparatus password A to the information storage apparatus 100. The authentication processing unit 302 of the information storage apparatus 100 authenticates the access from the host apparatus A in the case of the authentication password where the apparatus password A is registered. As the authentication succeeds by the apparatus password A, the input of the user input password B may not be necessary. The authentication result storage unit 303 at this time stores “OK” indicating that the authentication by the apparatus password A succeeds and “−” indicating that no input of the user input password B is being required in this example.

FIG. 23 shows a coping process for a case where the authentication processing cannot be performed between the host apparatus A and the information storage apparatus 100. In general, the host apparatus first transmits the apparatus password A to the information storage apparatus 100 through the execution of the BIOS. Also, in a case where the authentication by the apparatus password A does not succeed, the host apparatus does not activate a program for instructing the user to input the user input password B. In that case, if the host apparatus A malfunctions and cannot be used, the access to the information storage apparatus 100 cannot be made. In view of the above, for example, as shown in FIG. 23, by using the host apparatus B instead of the host apparatus A, the access is made to the information storage apparatus 100. In this case, the host apparatus B is connected to the information storage apparatus 100 via a cable from an interface which is not activated, for example. According to this, in the host apparatus B, the processing of transmitting the apparatus password B to the information storage apparatus 100 is not activated through the execution of the BIOS. It should be noted that the host apparatus B has the apparatus password B, and even when the apparatus password B is transmitted to the information storage apparatus 100, the authentication does not succeed.

Next, in the host apparatus B, the program for instructing the user to input the user input password B is activated, and the input of the password is accepted from the user. If the user inputs the user input password B, the authentication processing unit 302 of the information storage apparatus 100 permits the access from the host apparatus B. The authentication result storage unit 303 at this time stores “−” indicating that no input of the apparatus password A is made and “OK” indicating that the authentication by the user input password B succeeds.

It should be noted that as being different from the above-mentioned configuration, in a case where the authentication by the apparatus password A fails, the host apparatus B may activate a program for permitting the input of the user input password B.

(b) Second Modified Example

According to the above-mentioned embodiment, when the host apparatus 200 accesses the data storage units 304 and 305, the data switching unit 310 switches the access destination in accordance with the authentication result or the like. However, when the host apparatus 200 accesses the restricted-access data storage unit 304 among the data storage units 304 and 305, the data switching unit 310 may switch the access destination in accordance with the authentication result or the like. For example, when it is determined that the access destination of the host apparatus 200 is other than the restricted-access data area at the address Y1 to Y2, the data switching unit 310 accesses the access destination as it is irrespective of the authentication result. On the other hand, when it is determined that the access destination of the host apparatus 200 is within the restricted-access data area at the address Y1 to Y2, the data switching unit 310 refers to the authentication result storage unit 303 and the data switching table 307 to switch the access destination. In one case, it is supposed that the data switching unit 310 determines that the authentication result of the authentication result storage unit 303 is “NG” and also the switching to the dummy data is “valid” by referring to the data switching table 307. In this case, the data switching unit 310 prohibits the access to the restricted-access data storage unit 304 and instead performs read, write, or the like of the dummy data in the dummy data storage unit 305.

### (c) Other Modified Examples

According to the above-mentioned embodiment example, the information storage apparatus 100 and the host apparatus 200 are described as separate apparatuses. However, the information storage apparatus 100 may be built in the host apparatus 200. Stated differently, the information storage apparatus 100 and the host apparatus 200 may be an integrated apparatus.

According to the above-mentioned embodiment example, the storage areas of the data storage units 304 and 305 have the restricted-access area 100a and the dummy data area 100b. In addition, the storage area may include, for example, an OS for the information storage apparatus, an unrestricted-access area where no access restriction is imposed, and the like.

Also, the number of areas for the count areas and the non-count areas is not limited to that of the above-mentioned embodiment example.

Also, the data stored in the restricted-access area 100a is set as the restricted-access data, and the data stored in the dummy data area 100b is set as the dummy data, but the type of data is not particularly limited.

Also, a computer program for instructing a computer to execute the above-mentioned method and a computer-readable recording medium recording the program area are included in the scope of the present invention. Herein, as the computer-readable recording medium, for example, a flexible disk, a hard disk, a CD-ROM (Compact Disc-Read Only Memory), an MO (Magneto Optical disk), a DVD, a DVD-ROM, a DVD-RAM (DVD-Random Access Memory), a BD (Blue-ray Disc), a USB memory, a semiconductor memory, and the like can be exemplified. The above-mentioned computer program is not limited to one recorded on the above-mentioned recording medium but also may be one transmitted via a telecommunication line, a wireless or wired communication line, a network represented by the internet, or the like. It should be however noted that the computer-readable recording medium does not include carrier waves in which the computer program is embedded. Even in the case of the computer program embedded in the carrier waves to be transmitted, the computer-readable recording medium recording the program is a physically substantial recording medium which is reproduced in a recording medium reading apparatus connected to the computer at the transmission origin.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

1. An information storage apparatus for performing data input and output, the apparatus comprising:
an access acceptance unit to receive an access request associated with an access from a host apparatus ;
an authentication processing unit to judge whether the access is authenticated or unauthenticated ;
a storage unit including a first area that stores first data, and a second area that stores second data serving as a substitute for the first data, and that measuring access statuses;
a data switching unit to allow, when the access acceptance unit judges the access as authenticated, the access to the first data in the first area and, when the access acceptance unit judges the access as unauthenticated, switches the access to the second data in the second area, the access to the second data in the second area being provided to disguise that the access was unauthenticated.

2. The information storage apparatus according to claim 1, wherein one of the first area and the second area have a target area serving as a target for measuring a first access status including one of a number of accesses from the host apparatus and an access duration and a non-target area excluding measurement of the first access status; and
the information storage apparatus further includes:
an access measurement unit to measure the first access status when it is determined that the access from the host apparatus is an access to the target area in a case where the authentication processing unit judges the access as unauthenticated; and
an invalidation unit to invalidate the first data in the first area based on a result of comparing a measurement result in the access measurement unit with a threshold.

3. The information storage apparatus according to claim 2, further comprising:
a target area decision unit to measure, in a case where the authentication processing unit judges the access as authenticated, a second access status including at least one of a number of accesses and an access duration for every access to one of the first area and the second area from the host apparatus and deciding the target area based on the second access status.

4. The information storage apparatus according to claim 2, further comprising:
a first processing unit to accept, in a case where the authentication processing unit judges the access as authenticated, the access from the host apparatus and allowing the access to the first area; and
a second processing unit to accept, in a case where the authentication processing unit judges the access as unathenticated, the access from the host apparatus and allowing the access to the second area,
wherein the data switching unit activates the first processing unit in a case where the authentication processing unit judges the access as authenticated and activates the second processing unit in a case where the authentication processing unit judges the access as unathenticated, and
wherein the access measurement unit measures the first access status when the access accepted by the second processing unit from the host apparatus is the access to the target area of the first area or the second area.

5. The information storage apparatus according to claim 1, further comprising:
a first processing unit to accept, in a case where the authentication processing unit judges the access as authenticated, the access from the host apparatus and allowing the access to the first area; and
a second processing unit to accepting, in a case where the authentication processing unit judges the access as unathenticated, the access from the host apparatus and allowing the access to the second area,
wherein the data switching unit activates the first processing unit in a case where the authentication processing unit judges the access as authenticated and activates the second processing unit in a case where the authentication processing unit judges the access as unathenticated.

6. The information storage apparatus according to claim 1,
wherein between the host apparatus and the information storage apparatus, an apparatus password unique to the host apparatus and a user password set by a user of the host apparatus are set, and
wherein the authentication processing unit judges whether an access to the storage unit is authenticated or unauthenticated based on at least one of the apparatus password and the user password.

7. A computer-readable recording medium recording an information storage program for causing a processor of an information storage apparatus to execute a processing comprising:
accepting an access from a host apparatus to an information storage apparatus;
determining whether or not the access is authenticated;
letting the access to a first area of a storage unit of the information storage apparatus including the first area and a second area in a case where the authentication succeeds and switching the access to the second area in a case where the authentication fails;
measuring, when it is determined that the access from the host apparatus is an access to a target area serving as a target for measuring an access status from the host apparatus in a case where the authentication fails, the access status; and
invalidating data in the first area on the basis of a result of comparing the measurement result with a threshold.

8. An information storage method comprising:
accepting an access from a host apparatus to an information storage apparatus;
determining whether or not the access is authenticated;
letting the access to a first area of a storage unit of the information storage apparatus including the first area and a second area in a case where the authentication succeeds and switching the access to the second area in a case where the authentication fails;
measuring, when it is determined that the access from the host apparatus is an access to a target area serving as a target for measuring an access status from the host apparatus in a case where the authentication fails, the access status; and
determining whether or not data in the first area is invalidated on the basis of a result of comparing the measurement result with a threshold.
